(19) United States
(12) Patent Application Publication
(10) Pub. No.: US 2011/0134348 A1
(43) Pub. Date: Jun. 9, 2011

(54) LIQUID CRYSTAL DISPLAY DEVICE

(76) Inventors: Katsuhiko Morishita, Osaka (JP); Toshihiro Matsumoto, Osaka (JP); Tsuyoshi Okazaki, Osaka (JP); Hajime Imai, Osaka (JP)

(21) Appl. No.: 12/992,324

(22) PCT Filed: Jan. 30, 2009
(86) PCT No.: PCT/JP2009/051628

§ 371 Date: Feb. 14, 2011

(30) Foreign Application Priority Data
May 12, 2008 (JP) 2008-125199

(51) Int. Cl. G02F 1/1343; G02F 1/1333

(52) U.S. Cl. 349/33

(57) ABSTRACT

The present invention provides a TBA-mode transflective liquid crystal display device in which components such as a multigap structure and a quarter-wave plate can be omitted. The liquid crystal display device includes: a first substrate and a second substrate that are disposed opposite each other; and a liquid crystal layer that is interposed between the first substrate and the second substrate, and having, in a pixel area, a reflective area where reflective display is performed and a transmissive area where transmissive display is performed, wherein the first substrate has a first electrode provided in the transmissive area and the reflective area, a second electrode provided in the transmissive area and disposed parallel to and opposite the first electrode inside the pixel area, and a third electrode provided in the reflective area and disposed parallel to and opposite the first electrode inside the pixel area, the liquid crystal layer includes a p-type nematic liquid crystal and is driven by an electric field generated at least one of between the first electrode and the second electrode and between the first electrode and the third electrode, the p-type nematic liquid crystal is aligned perpendicular to the first substrate and the second substrate when no voltage is applied, a distance between the first electrode and the third electrode is different from a distance between the first electrode and the second electrode, and mutually different common signals are input to the second electrode and the third electrode.

### TECHNICAL FIELD

The present invention relates to a liquid crystal display device. More specifically, the present intention relates to a display device that is suitably used for liquid crystal display in a transverse bend alignment (TBA) mode.

### BACKGROUND ART

Liquid crystal display devices are widely used in electronic devices such as monitors, projectors, cellular phones, and portable information terminals (PDA). The display in a liquid crystal display device can be, for example, of transmission, reflection, and transflective type. Among these types, transmission type liquid crystal display devices that employ backlight are mainly used in a comparatively dark environment such as an indoor environment, and reflection type liquid crystal display devices that employ ambient light are mainly used in a comparatively bright environment such as an outdoor environment. Transflective type liquid crystal display devices can be in both the transmissive mode and the reflective mode and can perform mainly the transmissive display indoors and the reflective display outdoors. For this reason, transflective type liquid crystal display devices can ensure high-grade display under various environments, both indoors and outdoors, and are used in large numbers in mobile devices such as cellular phones, PDA, and digital cameras. In the transflective type liquid crystal display devices, for example, a vertical alignment (VA) mode is used as a display mode. In the VA mode, when the applied voltage is OFF, liquid crystal molecules are aligned perpendicular to the substrate surface, and when the applied voltage is ON, the display is performed by causing the liquid crystal molecules to tumble.

However, in the transflective type liquid crystal display devices, the reflected light passes through the liquid crystal layer twice, whereas the transmitted light passes through the liquid crystal layer only once. Therefore, when an optimum cell gap is designed for the reflected light, the transmittance of the transmitted light becomes about half the optimum value. For example, a method for forming a multigap structure in which a cell gap in the transmissive area differs from that in the reflective area, and the thickness of the liquid crystal layer in the reflective area is decreased has been disclosed as a means for resolving the above-described problem. However, this method requires a concavo-convex structure to be provided on the substrate and therefore the structure becomes complex. In addition, high accuracy is required in the manufacturing process.

In addition to the VA mode, an IPS mode and a FFS mode are known as modes suitable for liquid crystal display devices. In the IPS mode and FFS mode, the display is performed by rotating liquid crystal molecules in the substrate plane by a transverse electric field between pairs of electrodes for liquid crystal drive that are provided on one substrate. A transflective type liquid crystal display device operating in the IPS mode has also been disclosed (see, for example, Patent Documents 1 and 2).

Further, a TBA mode is known as a liquid crystal mode in a transverse electric field (see, for example, Patent Documents 3 to 9). In the TBA mode, the display is performed by bending the vertically aligned liquid crystal molecules in the horizontal direction by a transverse electric field created by electrode pairs for liquid crystal drive provided on one substrate. However, a transflective TBA-mode liquid crystal display device has not been disclosed.

Further, in the conventional transflective type liquid crystal display device, a retarder (quarter-wave plate) generating a retardation of λ/4 is provided at the back surface side and observation surface side of the liquid crystal display panel. Thus, the conventional transflective type liquid crystal display device has at least a total of two (one on the front surface and one on the back surface) retarders.

In the conventional transflective type liquid crystal display device, a quarter-wave plate necessary for performing the reflective display is disposed over the entire surface (both the transmissive area and the reflective area) on the back surface side and the observation surface side of the liquid crystal display panel. However, in such a configuration, since a quarter-wave plate that is essentially not necessary for the transmissive display is also disposed in the transmissive area, the contrast characteristic in the transmissive display is easily degraded with respect to that of the transmission type liquid crystal display device. Further, the number of retarders used is larger than that in the reflection type liquid crystal display device and transmission type liquid crystal display device, and accordingly the cost is increased and the thickness of the module (module thickness) is increased. Thus, there is space for improvement.
Patent Document 1: Japanese Kokai Publication No. 2007-4126
Patent Document 2: International Patent Application Publication No. 2008/001507
Patent Document 3: Japanese Kokai Publication No. S57-618
Patent Document 4: Japanese Kokai Publication No. H10-186351
Patent Document 5: Japanese Kokai Publication No. H10-333171
Patent Document 6: Japanese Kokai Publication No. H11-24068
Patent Document 7: Japanese Kokai Publication No. 2000-275682
Patent Document 8: Japanese Kokai Publication No. 2002-55357
Patent Document 9: Japanese Kokai Publication No. 2001-159759

### DISCLOSURE OF THE INVENTION

The present invention was contrived in view of the above circumstances and its object is to provide a TBA-mode transflective liquid crystal display device in which components such as a multigap structure and a quarter-wave plate can be omitted.

The inventors have conducted a comprehensive study of TBA-mode transflective liquid crystal display devices in which components such as a multigap structure and a quarter-wave plate could be omitted, and focused their attention on electrode pairs for driving the liquid crystals. It was found that the reflective display and transmissive display can be performed in a TEA mode, while enabling the omission of components such as a multigap structure and a quarter-wave plate, by using a configuration in which a first electrode is provided in a transmissive area and a reflective area, a second electrode is provided in the transmissive area and disposed parallel to and opposite the first electrode inside the pixel area, and a third electrode provided in the reflective area and disposed parallel to and opposite the first electrode inside the pixel area, creating the difference between the distance between the first electrode and the third electrode and the distance between the first electrode and the second electrode, and then inputting different common signals to the second electrode and the third electrode. On the basis of this finding, the inventors have conceived of the possibility of resolving the above-described problems and created the present invention.

Thus, the present invention provides a liquid crystal display device including a first substrate and a second substrate that are disposed opposite each other and a liquid crystal layer that is interposed between the first substrate and the second substrate, and having, in a pixel area, a reflective area where reflective display is performed and a transmissive area where transmissive display is performed, wherein the first substrate has a first electrode provided in the transmissive area and the reflective area, a second electrode provided in the transmissive area and disposed parallel to and opposite the first electrode inside the pixel area, and a third electrode provided in the reflective area and disposed parallel to and opposite the first electrode inside the pixel area; the liquid crystal layer includes a p-type nematic liquid crystal and is driven by an electric field generated at least one of between the first electrode and the second electrode and between the first electrode and the third electrode; the p-type nematic liquid crystal is aligned perpendicular to the first substrate and the second substrate when no voltage is applied; a distance between the first electrode and the third electrode is different from a distance between the first electrode and the second electrode, and mutually different common signals are input to the second electrode and the third electrode.

In accordance with the present invention, a distance between the first electrode and the third electrode in the reflective area is different from a distance between the first electrode and the second electrode in the transmissive area and therefore the intensity of electric field generated in the liquid crystal layer in the reflective area and the intensity of electric field generated in the liquid crystal layer in the transmissive area can be adjusted separately. Therefore, even when the cell gaps in the reflective area and the transmissive area are equal to each other, the phase difference (retardation) of the liquid crystal layer in the TBA-mode liquid crystal display device can be made less in the reflective area, more specifically about half, than in the transmissive area. Thus, in the TBA-mode liquid crystal display device, the retardation of the liquid crystal layer in the reflective area can be set to about half the retardation of the liquid crystal layer in the transmissive area, without providing a multigap structure. Further, since mutually different common signals are input to the second electrode and the third electrode, white and black of the reflective display and transmissive display can be matched without providing a quarter-wave plate. It follows from above that it is possible to provide a TBA-mode transflective liquid crystal display device in which components such as a multigap structure and a quarter-wave plate can be omitted.

Further, “parallel” as referred to herein is preferably perfectly parallel, but is not necessarily parallel in the strict sense of the word, and also includes a configuration that can be treated as substantially parallel with consideration for the effect of the present invention. It may also mean parallel to a degree that can be attained when the first electrode and second electrode, and the first electrode and second electrode are designed and formed so as to be parallel, and it goes without saying that an error that can occur in the production process may be also included. Thus, “parallel” as referred to herein includes an error within a range in which the effect of the present invention is demonstrated.

Further, “perpendicular” as referred to herein is not necessarily perpendicular in the strict sense of the word, and also includes a configuration that can be treated as substantially perpendicular with consideration for the effect of the present invention. It may also include an error that can occur in the production process. Thus, “perpendicular” as referred to herein includes an error within a range in which the effect of the present invention is demonstrated.

The configuration of the liquid crystal display device of the present invention is not especially limited as long as the above-mentioned components are particularly included. The liquid crystal display device may or may not comprise other components.

The preferred embodiments of the liquid crystal display device in accordance with the present invention will be described below in greater details. The below-described various embodiments may be appropriately combined together.

It is preferred that a pulse potential be applied to one of the second electrode and the third electrode, and a predetermined potential be applied to the other of the second electrode and the third electrode. As a result, white and black of the reflective display and transmissive display can be easily matched.

It is preferred that the second electrode and the third electrode be connected to a gradation reference voltage generating circuit. As a result, it is not necessary to provide a common voltage generating circuit that is connected to a common electrode in the conventional liquid crystal display device and therefore the number of components can be further reduced.

The distance between the first electrode and the third electrode is preferably larger than the distance between the first electrode and the second electrode. As a result, in the TBA-mode liquid crystal display device, the intensity of electric field generated in the liquid crystal layer in the reflective area can be made less than the intensity of electric field generated in the liquid crystal layer in the transmissive area. Therefore, the retardation of the liquid crystal layer in the reflective area can be easily set to about half the retardation of the liquid crystal layer in the transmissive area.

It is preferred that the first electrode, the second electrode, and the third electrode have substantially the same width. As a result, in the TBA-mode liquid crystal display device, the retardation of the liquid crystal layer in the transmissive area and the retardation of the liquid crystal layer in the reflective area can be easily varied (made different). Therefore, the retardation of the liquid crystal layer in the reflective area can be easily set to about half the retardation of the liquid crystal layer in the transmissive area.

Further, “substantially equal” as referred to herein is preferably perfectly equal, but is not necessarily equal in the strict sense of the word, and also includes a relationship that can be treated as substantially equal with consideration for the effect of the present invention. It may also mean equal to a degree that can be attained when the first electrode, the second electrode, and the third electrode are designed and formed so as to be equal, and it goes without saying that an error that can occur in the production process may be also included. Thus, “substantially equal” as referred to herein includes an error within a range in which the effect of the present invention is demonstrated.

The first electrode, the second electrode, and the third electrode are preferably comb-shaped electrodes. As a result, a high-density transverse electric field can be formed between the first electrode and the second electrode, and between the first electrode and the third electrode, and the liquid crystal layer can be controlled with high accuracy.

From the standpoint of performing fine adjustment of retardation of the liquid crystal layer in the transmissive area and reflective area, the liquid crystal display device in accordance with the present invention may be provided with a multigap structure, but from the standpoint of reducing the cost more reliably by omitting the multigap structure, it is preferred that the liquid crystal display device in accordance with the present invention have a single cell gap. Specifically, the thickness of the liquid crystal layer in the reflective area is preferably substantially equal to the thickness of the liquid crystal layer in the transmissive area.

Further, “substantially equal” as referred to herein is preferably perfectly equal, but is not necessarily equal in the strict sense of the word, and also includes a relationship that can be treated as substantially equal with consideration for the effect of the present invention. It may also mean equal to a degree that can be attained when the first substrate, second substrate, and liquid crystal layer are designed and formed so as to be equal, and it goes without saying that an error that can occur in the production process may be also included. Thus, “substantially equal” as referred to herein includes an error within a range in which the effect of the present invention is demonstrated.

The pixel is the smallest unit constituting a displayed image. In an active matrix liquid crystal display device with color display, a pixel is usually an area constituted by sub-pixels (monochromatic areas) of a plurality of colors (for example, three colors). Therefore, when the liquid crystal display device in accordance with the present invention is applied to an active matrix liquid crystal display device with color display, the pixel (pixel area) is preferably a sub-pixel (sub-pixel area).

As long as the liquid crystal display device in accordance with the present invention has the above-described features, the control system (liquid crystal mode) thereof is not particularly limited, but the aforementioned TBA mode is preferred.

### EFFECT OF THE INVENTION

In accordance with the present invention, it is possible to provide a TEA-mode liquid crystal display device in which components such as a multigap structure and a quarter-wave plate can be omitted.

### BEST MODES FOR CARRYING OUT THE INVENTION

The present invention will be described below in greater detail on the basis of embodiments thereof with reference to the appended drawings, but the present invention is not limited to these embodiments.

### Embodiment 1

A liquid crystal display device of the present embodiment is of a transflective type that uses the so-called TBA system of transverse field systems in which image display is performed by causing an electric field (transverse electric field) in the direction of substrate plane to act upon a liquid crystal layer and controlling the alignment.

FIG. 1 is a plan schematic view illustrating the configuration of a liquid crystal display panel of Embodiment 1. FIG. 2(a) is a plan schematic view illustrating the configuration of one sub-pixel of the liquid crystal display panel of Embodiment 1. FIG. 2(b) is a schematic diagram illustrating mutual arrangement of transmission axes of polarizing plates in Embodiment 1. FIG. 3 is a cross-sectional schematic diagram illustrating the configuration of the liquid crystal display panel of Embodiment 1; this figure shows a cross section taken along line X-Y in FIG. 2(a). FIG. 4 is a plan schematic view illustrating the circuit configuration of the liquid crystal display device of Embodiment 1. In FIG. 1, for the sake of simplification, only two (upper and lower) sub-pixels are shown, but the sub-pixels are actually arranged in the up-down and left-right matrix-like configuration.

A pixel electrode 20 and a thin film transistor (TFT) 26 for switching the pixel electrode 20 are formed in each of a plurality of sub-pixel areas formed as a matrix and constituting a display area (image display area) 81 of the liquid crystal display device of the present embodiment. A plurality of source bus lines 16 are extended from a source driver (data line drive circuit) 71. A source of the TFT 26 is electrically connected to the corresponding source bus line 16. The source driver 71 supplies an image signal to each sub-pixel via the plurality of source bus lines 16. Further, two common electrodes 21, 29 are formed in the display area 81 and a picture-frame area (image non-display area) of the liquid crystal display device of the present embodiment.

A plurality of gate bus lines 12 extending from the gate driver (scanning line drive circuit) 72 function as gates of the TFTs 26. Further, scan signals supplied in the pulse-like form to the plurality of gate bus lines 12 at a predetermined timing from the gate driver 72 are successively applied to the TFTs 26 in a linear order. Each pixel electrode 20 is electrically connected to a drain (drain line 18) of the TFT 26. An image signal supplied from the source bus line 16 is applied at the predetermined timing to the pixel electrode 20 connected to the TFT 26 that has been switched ON for a fixed period by the input of the scan signal.

An image signal of a predetermined level that has been written in a liquid crystal layer 30 is stored for a predetermined period between the pixel electrode 20 to which the image signal has been applied and the common electrodes 21, 29 facing this pixel electrode 20. In this case, a storage capacitance is formed in parallel with a liquid crystal capacitance formed between these pixel electrode 20 and common electrodes 21, 29, for preventing leakage of the image signals stored. The storage capacitance is formed, in each sub-pixel, between the drain line 18 of the TFT 26 and a Cs bus line (capacitance storage line) 13.

The common electrodes 21, 29 are connected to a gradation reference voltage generating circuit 73. The gradation reference voltage generating circuit 73 generates a gradation reference voltage serving as a reference for display gradation. More specifically, this circuit generates voltages of black gradation, first halftone, second halftone, and white gradation. The common electrode 21 is set to the black gradation reference voltage (lowest gradation voltage), whereas the common electrode 29 is set to the white gradation reference voltage (highest gradation voltage). The number of gradation reference voltages (the number of gradations) output by the gradation reference voltage generating circuit 73 is not particularly limited and can be set appropriately.

In addition to the gradation reference voltage generating circuit 73, the liquid crystal display device of the present embodiments includes a vertical timing control circuit 75, a horizontal timing control circuit 76, and an image data conversion circuit 77. The circuits 75, 76, and 77 transmit signals from the external signal source 74 to the source driver 71 and the gate driver 72 at a predetermined timing and image signal.

The detailed configuration of the liquid crystal display device of the present embodiment will be explained below. The liquid crystal display device of the present embodiment is provided with a liquid crystal display panel 100 and a backlight unit (not shown in the figure) provided at the back surface side of the liquid crystal display panel 100. The liquid crystal display panel 100 is provided with an active matrix substrate (TFT array substrate) 10, an counter substrate 50 facing the active matrix substrate 10, and a liquid crystal layer 30 interposed therebetween.

The counter substrate 50 has a black matrix (BM) layer (not shown in the figure) that blocks the light between the sub-pixels, a plurality of color layers (color filters; not shown in the figure) provided correspondingly to each sub-pixel, and a vertical alignment film 55 provided on the surface on the liquid crystal layer 30 side to cover the aforementioned layers on the one main surface (on the liquid crystal layer 30 side) of a colorless transparent insulating substrate 51. The BM layer is formed from a non-transparent metal such as Cr or a non-transparent organic film such as an acrylic resin including carbon and is formed around the sub-pixel area, that is, in an area corresponding to the below-described gate bus lines 12 and source bus lines 16. The color layer is used to perform color display, formed from a transparent organic film, for example, of an acrylic resin including a pigment, and mainly formed in the sub-pixel area.

Thus, the liquid crystal display device of the present embodiment is a color liquid crystal display device (active matrix liquid crystal display device for color display) provided with the color layer on the counter substrate 50, wherein one pixel is constituted by three sub-pixels outputting color light of R (red), G (green), and B (blue) colors, respectively. The number and types of colors of the sub-pixels constituting each pixel are not particularly limited and can be set appropriately. Thus, in the liquid crystal display device of the present embodiment, each pixel may be constituted, for example, by sub-pixels of three colors, namely cyan, magenta, and yellow, or may be constituted by sub-pixels of four or more colors.

The active matrix substrate 10 has a plurality of gate bus lines 12 that transmit scan signals, a plurality of Cs bus lines 13, a plurality of reflective layers 28, a plurality of source bus lines 16 that transmit image signals, a plurality of TFTs 26 that are switching elements, each being provided for one sub-pixel, a plurality of drain lines 18, each being connected to one TFT 26, a plurality of pixel electrodes 20 provided individually for each sub-pixel, two kinds of common electrodes 21, 29 provided commonly for the sub-pixels, and a vertical alignment film 25 provided on the surface at the liquid crystal layer 30 side to cover the above-described configuration on one main surface (on the liquid crystal layer 30 side) of a colorless transparent insulating substrate 11.

The vertical alignment films 25, 55 are formed by coating a well-known alignment film material such as a polyimide. The vertical alignment films 25, 55 are usually not subjected to rubbing, but can align the liquid crystal molecules substantially perpendicular to the film surface when no voltage is applied.

The gate bus lines 12 are extended parallel to each other in the left-right direction in the front view of the liquid crystal display panel 100, and the source bus lines 16 are extended parallel to each other in the direction perpendicular to the gate bus lines 12, that is, in the up-down direction in the front view of the liquid crystal display panel 100. The Cs bus lines 13 are extended parallel to the gate bus lines 12, that is, in the left-right direction in the front view of the liquid crystal display panel 100. Thus, the gate bus lines 12 and Cs bus lines 13 are disposed alternately and parallel to each other. In the present embodiment, each sub-pixel area is generally defined as an area surrounded by these gate bus lines 12 and source bus lines 16, and these areas are arranged in a matrix-like configuration.

The configuration of the present embodiment will be described below in greater detail by paying attention mainly to one sub-pixel.

The Cs bus line 13 is disposed so as to pass close to the center of each sub-pixel area, and a high-reflectance reflective layer 28 is provided in an area that is substantially half the sub-pixel area partitioned by the Cs bus line 13. The area that is substantially half the sub-pixel area where the reflective layer 28 has been provided is thus a reflective area R where the reflective display is performed, and the area taking the remaining half of the sub-pixel area where the reflective layer 28 has not been provided is a transmissive area T where the transmissive display is performed. The reflective layer 28 is obtained by patterning a metal film with light reflection ability, such as an aluminum or silver film. It is preferred that the reflective layer 28 has concavities and convexities formed on the surface thereof to provide the layer with light scattering ability. As a result, visibility in reflective display can be improved. The area ratio of the transmissive area T and reflective area R can be appropriately set according to the desired display characteristics.

The pixel electrode 20 is formed from a transparent conductive film such as an ITO film or a metal film such as an aluminum or chromium film. The pixel electrode 20 has a comb-like shape in a planar view of the liquid crystal display panel 100. More specifically, the pixel electrode 20 has a band-like (rectangular in a planar view) trunk portion 20a arranged to lay flatly upon the Cs bus line a plurality of band-like (rectangular in a planar view) branch portions 20b connected to the trunk portion 20a and extended toward the transmissive area T side, and a plurality of band-like (rectangular in a planar view) branch portions 20c connected to the trunk portion 20a and extended toward the reflective area R side. The branch portions 20b and the branch portions 20c are disposed parallel to each other in the up-down direction in the front view of the liquid crystal display panel 100.

The common electrodes 21, 29 is also formed from a transparent conductive film such as an ITO film or a metal film such as an aluminum film and has a comb-like shape in the planar view. More specifically, the common electrode 21 has a base trunk portion 21d provided in the picture-frame area, band-shaped (rectangular in a planar view) trunk portions 21a disposed to overlap planarly the gate bus lines 12, and a plurality of band-shaped (rectangular in a planar view) branch portions 21b that are connected to the trunk portions 21a and extend to the transmissive area T of sub-pixels adjacent in the vertical direction in the front view of the liquid crystal display panel 100. By contrast, the common electrode 29 has a base trunk portion 29d provided in the picture-frame area, band-shaped (rectangular in a planar view) trunk portions 29a disposed to overlap planarly the gate bus lines 12, and a plurality of band-shaped (rectangular in a planar view) branch portions 29c that are connected to the trunk portions 29a and extend to the reflective area R of sub-pixels adjacent in the vertical direction in the front view of the liquid crystal display panel 100. The trunk portions 21a of the common electrode 21 and the trunk portions 29a of the common electrode 29 are disposed alternately so as to overlap planarly the gate bus lines 12, and the branch portions 21b of the common electrode 21 and the branch portions 29c of the common electrode 29 are disposed parallel to each other in the vertical direction in the front view of the liquid crystal display panel 100. Further, the trunk portions 21a of the common electrode 21 and the trunk portions 29a of the common electrode 29 are shared by the pixels adjacent in the vertical direction in the front view of the liquid crystal display panel 100. As a result, the transmissive area T and the reflective area R are disposed opposite each other in the vertical direction between the sub-pixels adjacent in the vertical direction in the front view of the liquid crystal display panel 100. The base trunk portion 21d of the common electrode 21 and the base trunk portion 29d of the common electrode 29 are provided at the opposing ends of the picture-frame area. The common electrode 21 and the common electrode 29 also have band-shaped (rectangular in a planar view) line portions (line overlapping portions) connected to the trunk portion 21a and the trunk portion 29a, respectively, and disposed to overlap planarly the source bus lines 16.

In this configuration, the branch portions 20b of the pixel electrode 20 and the branch portions 21b of the common electrode 21 and also the branch portions 20c of the pixel electrode 20 and the branch portions 29c of the common electrode 29 have mutually complementary planar shapes and are disposed alternately with a certain spacing. Thus, the branch portions 20b of the pixel electrode 20 and the branch portions 21b of the common electrode 21 and also the branch portions 20c of the pixel electrode 20 and the branch portions 29c of the common electrode 29 are disposed opposite each other and parallel each other in the same plane. In other words, the comb-shaped pixel electrode 20 and the comb-shaped common electrode 21 are disposed opposite each other so that the teeth thereof interdigitate in the transmissive area T, and the comb-shaped pixel electrode 20 and the comb-shaped common electrode 29 are disposed opposite each other so that the teeth thereof interdigitate in the reflective area R. As a result, a high-density transverse electric field can be formed between the pixel electrode 20 and the common electrodes 21, 29 and the liquid crystal layer 30 can be controlled with higher accuracy.

The width (length in the short side direction) of the branch portion 20b and the branch portion 20c of the pixel electrode 20, the width (length in the short side direction) of the branch portion 21b of the common electrode 21, and the width (length in the short side direction) of the branch portion 29c of the common electrode 29 are all substantially equal to each other. From the standpoint of increasing the transmittance, it is preferred that the widths of the pixel electrode 20 and the common electrodes 21, 29 (the width of the branch portion 20b and the branch portion 20c of the pixel electrode 20, the width of the branch portion 21b of the common electrode 21, and the width of the branch portion 29c of the common electrode 29) be as small as possible. According to the presently used process rule, the widths may be set, for example, to about 1.0 to 4.0 μm.

The distance between the branch portion 20c and the branch portion 29c provided in the reflective area R is larger than the distance between the branch portion 20b and the branch portion 21b provided in the transmissive area T. More specifically, from the standpoint of making the retardation of the liquid crystal layer 30 in the reflective area R about half the retardation of the liquid crystal layer 30 in the transmissive area T, as will be described hereinbelow, when the widths of the pixel electrode 20 and the common electrodes 21, 29 (the width of the branch portion 20b and the branch portion 20c of the pixel electrode 20, the width of the branch portion 21b of the common electrode 21, and the width of the branch portion 29c of the common electrode 29) are equal to each other, it is preferred that the distance between the branch portion 20c and the branch portion 29c provided in the reflective area R be by a factor of 1.1 to 2.0 (more preferably by a factor of 1.3 to 1.8) larger than the distance between the branch portion 20b and the branch portion 21b provided in the transmissive area T.

The TFT 26 is provided close to the intersection portion of the gate bus line 12 and the source bus line 16 and has a semiconductor layer 15 formed from an island-shaped amorphous silicon film that is partially formed inside a planar area of the gate bus line 12, and the source line 17 and the drain line 18 that are formed to overlap partially and planarly the semiconductor layer 15. The gate bus line 12 functions as a gate electrode of the TFT 26 in a position where the semiconductor layer 15 is planarly overlapped. Thus, the TFT 26 is of a channel etch type manufactured by a method in which the semiconductor layer 15 is also somewhat etched when the drain line 18 and the source line 17 are separated and of a reverse stagger type in which the gate bus line 12 that also functions as a gate electrode is provided below (at the insulating substrate 11 side) the drain line 18 and the source line 17.

The source line 17 is branched off the source bus line 16 and has a substantially L-like shape in a planar view that extends to the semiconductor layer 15, thereby connecting the source bus line 16 and the TFT 26. The drain line 18 extends from the semiconductor layer 15 and has an L-like shape in a planar view. This line is connected to the pixel electrode 20 and forms the storage capacitance. More specifically, the drain line 18 has a storage capacitance portion 22 of a substantially rectangular shape in a planar view at the end portion (distal end portion of L-like shape) on the side opposite that of the TFT 26, and the storage capacitance portion 22 is formed to overlap planarly the Cs bus line 13. Further, a storage capacitance having the storage capacitance portion 22 and the Cs bus line 13 as electrodes is formed in a region where the storage capacitance portion 22 and the Cs bus line 13 planarly overlap. The storage capacitance portion 22 is also disposed to overlap planarly the trunk portion 20a of the pixel electrode 20 and is electrically connected to the trunk portion 20a of the pixel electrode 20 by a contact hole 27 provided in the same position.

The cross-sectional structure of the liquid crystal display panel 100 will be described below.

The liquid crystal display panel 100 is provided with the active matrix substrate 10, the counter substrate 50 disposed opposite the active matrix substrate 10, and the liquid crystal layer 30 interposed therebetween. A polarizing plate 42 is laminated on the outer surface side (side opposite that of the liquid crystal layer 30) of the active matrix substrate 10, and a polarizing plate 41 is laminated on the outer surface side of the counter substrate 50. Thus, the liquid crystal display panel 100 is not provided with a λ/4 retarder (quarter-wave plate) that is provided in the conventional transflective liquid crystal display device.

Further, the liquid crystal display device of the present embodiment may have a viewing angle compensation film or a retarder other than the λ/4 retarder for reflective display.

The active matrix substrate 10 has the transparent insulating substrate 11 made from glass, quartz, or plastic as a base body. The reflective layer 28 formed from a metal film such as an aluminum or silver film is disposed locally in the sub-pixel area at the inner surface side (liquid crystal layer 30 side) of the insulating substrate 11. An interlayer insulating film 23 formed from a transparent insulating material such as silicon oxide is disposed so as to cover the reflective layer 28. The gate bus lines 12 and the Cs bus lines 13 formed from a metal film such as an aluminum film are disposed on the interlayer insulating film 23, and a gate insulator 14 formed from a transparent insulating material such as silicon oxide is disposed so as to cover the gate bus lines 12 and the Cs bus lines 13.

Where the Cs bus lines 13 are formed by using a material with a high reflectivity to have a large width so as to cover the reflective area R, the Cs bus lines 13 can be also used as the reflective layer 28 and the manufacturing process can be simplified.

The amorphous silicon semiconductor layer 15 is formed on the gate insulator 14, and the source line 17 and the drain line 18 formed from a metal film such as an aluminum film are provided so as to be partially placed on the semiconductor layer 15. The source line 17 is formed integrally with the source bus line 16, as shown in FIG. 2.

An interlayer insulating film 19 formed from silicon oxide or the like is disposed so as to cover the semiconductor layer 15, source line 17, source bus line 16, and drain line 18. A planarizing film 24 formed from a transparent insulating material such as a photosensitive acrylic resin is disposed on the interlayer insulating film 19, and the pixel electrodes 20 and the common electrode 21 formed from a transparent conductive material such as ITO or a metal film such as an aluminum film are disposed on the surface of the planarizing film 24. The pixel electrodes 20 are electrically connected to the drain lines 18 via the contact holes 27 that pass through the interlayer insulating film 19 and the planarizing film 24 and is located above the drain lines 18. The pixel electrodes 20 are thus partially embedded in the contact holes 27, thereby ensuring electric connection to the drain lines 18. The vertical alignment film 25 from a polyimide or the like is formed to cover the pixel electrodes 20 and the common electrode 21.

The counter substrate 50 has the transparent insulating substrate 51 made from glass, quartz, or plastic as a base body. The BM layer and color layer are provided, as described hereinabove, at the inner surface side (liquid crystal layer 30 side) of the insulating substrate 51. The vertically aligned film 55 from a polyimide or the like is formed to cover the BM layer and color layer. The color layer is preferably partitioned into two areas of different chromaticity inside the sub-pixel area. More specifically, a first color material area is provided correspondingly to a planar area of the transmissive area T, and a second color material area is provided correspondingly to a planar area of the reflective area R. A configuration in which the chromaticity of the first color material area is greater than the chromaticity of the second color material area can be used. As a result, the chromaticity of the display light can be prevented from being different in the transmissive area T where the display light passes through the color layer only once and the reflective area R where the display light passes twice through the color layer, the appearances of reflective display and transmissive display can be matched, and the display quality can be increased.

A planarizing film (undercoat film) formed from a transparent resin material is preferably further laminated on the BM layer and color layer on the liquid crystal layer 30 side thereof in order to planarize unevenness of the configurations. As a result, the surface of the counter substrate 50 can be planarized, thickness uniformity of the liquid crystal layer 30 can be improved, and the non-uniformity of driving voltage in the sub-pixel area and the decrease in contrast can be prevented.

The active matrix substrate 10 and the counter substrate 50 are attached, with a spacer such as plastic beads being interposed therebetween, by a sealing agent provided so as to surround the display area. The liquid crystal layer 30 is formed by sealing a liquid crystal material as a display medium constituting an optical modulation layer in the gap between the active matrix substrate 10 and the counter substrate 50.

The liquid crystal layer 30 includes a nematic liquid crystal material (p-type liquid crystal material) having positive dielectric anisotropy. Liquid crystal molecules of the p-nematic liquid crystal material demonstrate homeotropic alignment when no voltage is applied (when no electric field is generated by the pixel electrode 20 and the common electrode 21) under the effect of an alignment-controlling force of the vertical alignment films 25, 55 of the respective active matrix substrate 10 and the counter substrate 50. More specifically, when no voltage is applied, a long axis of a liquid crystal molecule of the p-type nematic liquid crystal material in the vicinity of the vertical alignment films 25, 55 has an angle of equal to or greater than 88° (preferably equal to or greater than 89°) with respect to the active matrix substrate 10 and the counter substrate 50. Further, the liquid crystal layer 30 is set to substantially the same thickness as the transmissive area T and the reflective area R. Thus, the liquid crystal display panel 100 has a single cell gap.

The arrangement of optical axes in the liquid crystal display device of the present embodiment is shown in FIG. 2(b). Both the transmission axis 41t of the polarizing plate 41 at the active matrix substrate 10 side and the transmission axis 42t of the polarizing plate 42 at the counter substrate 50 side are disposed at an angle of 45° to the branch portion 20b and the branch portion 20c of the pixel electrode 20 and the branch portion 21b of the common electrode 21 and the branch portion 29c of the common electrode 29 in the front view of the liquid crystal display panel 100, and the transmission axis 41t is disposed in a cross-Nicol state with the transmission axis 42t in the oblique (45°) direction in the front view of the liquid crystal display panel 100.

In the liquid crystal display device of the present embodiment that has the above-described configuration, when an image signal (voltage) is applied to the pixel electrode 20 via the TFT 26, an electric field in the substrate plane direction is generated between the pixel electrode 20 and the common electrodes 21, 29, this electric field drives the liquid crystal, transmittance and reflectance of each sub-pixel are changed, and image display is performed.

More specifically, in the liquid crystal display device of the present embodiment, where an electric field is applied, the retardation of the liquid crystal layer 30 is changed due to the distortion of alignment of liquid crystal molecules induced by the formation of electric field intensity distribution inside the liquid crystal layer 30. More specifically, the initial alignment state of the liquid crystal layer 30 is a homeotropic alignment, and where a voltage is applied to the comb-shaped pixel electrode 20 and common electrodes 21, 29, a transverse electric field is generated inside the liquid crystal layer 30, and a bend electric field is formed. As a result, as shown in FIG. 5, two domains that differ from each other in the director orientation by 180° are formed, and liquid crystal molecules of the nematic liquid crystal material show a bend liquid crystal arrangement (bend alignment) in each domain.

Thus, the liquid crystal display device of the present embodiment is a TBA-mode liquid crystal display device, and various transmitted light intensity (T)-voltage (V) characteristics can be obtained by changing the width of the pixel electrodes 20 and the common electrodes 21, 29 and the distance therebetween. FIGS. 25 and 26 are plan schematic diagrams illustrating configurations of liquid crystal display panels of Comparative Examples 1 and 2, respectively. As shown in FIG. 25, the liquid crystal display panel of Comparative Example 1 has a configuration identical to that of the liquid crystal display panel 100 of the present embodiment, except that no reflective layer is present and the layout of pixel electrodes and common electrode is different. As shown in FIG. 26, the liquid crystal display panel of Comparative Example 2 has a configuration identical to that of the liquid crystal display panel 100 of the present embodiment, except that no reflective layer is present, the layout of pixel electrodes, common electrode, and drain lines is different, and the arrangement locations of contact holes are different. Further, in the liquid crystal display panels of Comparative Examples 1 and 2, a common electrode 21 is provided in the reflective area R and the transmissive area T, the pixel electrode 20 and the common electrode 21 have a constant width in the sub-pixel area, and the distance between the pixel electrode 20 and the common electrode 21 is constant within the sub-pixel area. In the liquid crystal display panel of Comparative Example 1, the width (L) of the pixel electrode and common electrode is 4 μm and the distance (S) between the pixel electrode and common electrode is 4 μm. By contrast, in the liquid crystal display panel of Comparative Example 2, the width (L) of the pixel electrode and common electrode is 4 μm and the distance (S) between the pixel electrode and common electrode is 12 μm.

FIG. 27 shows a transmitted light intensity (T)−voltage (V) characteristic of the TBA-mode liquid crystal display panel in Comparative Examples 1 and 2. FIG. 27 also shows a transmitted light intensity (T)−voltage (V) characteristic that is ideal for reflective display. As a result, close to an applied voltage of 5.2 V, the transmittance of the liquid crystal display panel of Comparative Example 2 is about half the transmittance of the liquid crystal display panel of Comparative Example 1. Thus, it is clear that the phase difference (retardation) of the liquid crystal layer in the liquid crystal display panel of Comparative Example 2 can be set to about half the retardation of the liquid crystal layer in the liquid crystal display panel of Comparative Example 2. Thus, in the TBA-mode liquid crystal display device, various T−V characteristics can be obtained by appropriately adjusting the width of the pixel electrode and the width of the common electrode and the distance therebetween.

By contrast, in the liquid crystal display device of the present embodiment, the distance between the branch portion 20c and the branch portion 29c provided in the reflective area R is set larger than the distance between the branch portion 20b and the branch portion 21b provided in the transmissive area T. As a result, the intensity of an electric field generated in the liquid crystal layer 30 in the reflective area R becomes lower than the intensity of an electric field generated in the liquid crystal layer 30 in the transmissive area T. Therefore, although the cell gaps in the reflective area R and transmissive area T are identical, the retardation of the liquid crystal layer 30 in the reflective area R can be made less than, more specifically, about half the retardation in the transmissive area T. Thus, even though a multigap structure is not provided, the retardation of the liquid crystal layer 30 in the reflective area R can be set to about half the retardation of the liquid crystal layer 30 in the transmissive area T. As a result, it is possible to realize a TBA-mode liquid crystal display device in which both the reflective display and the transmissive display can be performed without providing a multigap structure. Thus, in the liquid crystal display device of the present embodiment, the retardation of the liquid crystal layer 30 in the transmissive area T is set to λ/2 and the retardation of the liquid crystal layer 30 in the reflective area R is set to λ/4.

The width of the branch portion 20b and the branch portion 20c of the pixel electrode 20, the width of the branch portion 21b of the common electrode 21, and the width of the branch portion 29c of the common electrode 29 are all substantially equal to each other. Therefore, the retardation of the liquid crystal layer 30 in the transmissive area T and the retardation of the liquid crystal layer 30 in the reflective area R can be easily changed (made different). Therefore, the retardation of the liquid crystal layer 30 in the reflective area R can be easily set to about half the retardation of the liquid crystal layer 30 in the transmissive area T.

The display operation of the liquid crystal display device of the present embodiment will be described below. FIG. 6 is a timing chart of the liquid crystal display device of Embodiment 1. FIG. 6(a) shows a state in which an image signal is not applied (black display). FIG. 6(b) shows a state in which an image signal is applied (white display). FIG. 7 is a cross-sectional schematic view illustrating the configuration of the liquid crystal display device of Embodiment 1 and the relationship of retardation, FIG. 7(a) illustrates the case in which no voltage is applied (black display), and FIG. 7(b) illustrates the case in which a voltage is applied (white display).

In FIG. 6, the Vd1 and Vcom2 signals are shifted with respect to each other so that the rise and fall thereof could be easily seen, but the signals actually rise and fall (change) simultaneously. In FIG. 6, the time and electric potential are plotted on the abscissa and ordinate, respectively. FIG. 7 shows an explanatory diagram, (on the right side in the figure) illustrating the operation in the reflective display mode (reflective area R) and an explanatory diagram (on the left side in the figure) illustrating the operation in the transmissive display mode (transmissive area T). The explanatory diagram illustrating the operation in the reflective display mode shows how the external light incident from above, as shown in the figure, propagates down, as shown in the figure, reaches the reflective layer, undergoes reflection at the reflective layer, returns to the upper side, as shown in the figure, and becomes display light. The explanatory diagram illustrating the operation in the transmissive display mode shows how the illumination light incident from below propagates upward and becomes the display light.

First, the signals applied to the electrodes will be explained.

As shown in FIGS. 6(a) and 6(b), an image signal Vd1 which is a potential with an amplitude changing depending on gradation is applied to the pixel electrode 20 in the same manner as in the typical liquid crystal display device. The liquid crystal display device of the present embodiment has an AC drive and the image signal Vd1 is a pulse signal (for example, a rectangular signal with a maximum amplitude of ±7 V) with a polarity reversed for each frame. A constant voltage (black gradation voltage) Vcom1 is applied from the gradation reference voltage generating circuit 73 to the common electrode 21 provided in the transmissive area T, and the common electrode is set to a constant potential (predetermined potential, for example 0 V) at all times. A white gradation voltage Vcom2 is applied from the gradation reference voltage generating circuit 73 to the common electrode 29 provided in the reflective area R. The white gradation voltage Vcom2 is a pulse signal (for example, a rectangular signal with a maximum amplitude of ±7 V) with a polarity reversed for each frame, and the white gradation voltage Vcom2 of the same polarity as the image signal Vd1 is applied to the common electrode 29. Therefore, the voltage applied to the liquid crystal layers 30 in the transmissive area T and the reflective area R when the image signal is not applied (during the black display) and when the image signal is applied (during the white display) is reversed in the transmissive area T and the reflective area R as shown in Table 1 below.

TABLE 1

Voltage applied to liquid crystal layer

| | When image | When image |
|---|---|---|
| | signal amplitude | signal amplitude |
| | is ±0 (V) | is ±7 (V) |
| Transmissive area T | ±0 | ±7 |
| Reflective area R | ±7 | ±0 |

As a result, when the reflective area R has an ideal transmitted light intensity (T)−voltage (V) characteristic, such as shown in FIG. 27, the liquid crystal display device of the present embodiment has a transmitted light intensity (T)−voltage (V) characteristic, such as shown in FIG. 8. Thus, in the transmissive area T, the transmittance increases as a voltage is applied to the pixel electrode 20, whereas in the reflective area R, the transmittance decreases as a voltage is applied to the pixel electrode 20. Further, the transmittance in the reflective area R is about half that in the transmissive area T.

The transmissive display (transmissive mode) of the liquid crystal display device of the present embodiment in which such voltage is applied will be explained below.

In the liquid crystal display device of the present embodiment, the light emitted from the backlight is converted into linearly polarized light parallel to the transmission axis 42t of the polarizing plate 42 when the light passes through the polarizing plate 42, and the converted light falls on the liquid crystal layer 30 of the liquid crystal display panel 100. When no image signal is applied, the incident light (linearly polarized light) exits the liquid crystal layer 30 and reaches the polarizing plate 41 in the same polarization state as at the time of incidence. The linearly polarized light that has reached the polarizing plate 41 is oriented perpendicular to the transmission axis 41t of the polarizing plate 41. Therefore, this light is absorbed by the polarizing plate 41 and the sub-pixels demonstrate the black display. Thus, since the retardation of the liquid crystal display panel in the transmissive area T is 0 when no image signal is applied, the black display occurs in a cross-Nicol state of polarizing plates 41, 42.

By contrast, when an image signal is applied, the linearly polarized light incident on the liquid crystal layer 30 is provided with a predetermined retardation (λ/2) by the liquid crystal layer 30 and converted into linearly polarized light orthogonal to the transmission axis 42t of the polarizing plate 42. The converted light exits the liquid crystal layer 30 and reaches the polarizing plate 41. Where this linearly polarized light reaches the polarizing plate 41, it passes through the polarizing plate 41 having the transmission axis 41t parallel to the polarization direction of the light and becomes visible. As a result, the sub-pixels create a white display. Thus, since the retardation of the liquid crystal display panel in the transmissive area T is λ/2 (liquid crystal layer 30 in the transmissive area T) when an image signal is applied, a white occurs in a cross-Nicol state of polarizing plates 41, 42.

The reflective display shown on the right side in FIG. 7 will be explained below.

In the reflective display mode, the light incident from above (outside) the polarizing plate 41 is converted into linearly polarized light parallel to the transmission axis 41t of the polarizing plate 41 when the light passes through the polarizing plate 41, and the converted light falls on the liquid crystal layer 30 of the liquid crystal display panel 100. When no image signal is applied, a voltage of ±7 V is applied to the liquid crystal layer 30 in the reflective area R, as shown in Table 1 above, and, the linearly polarized light incident on the liquid crystal layer 30 will be imparted with a predetermined retardation (λ/4) by the liquid crystal layer 30 in the reflective area R. As a result, the linearly polarized light is converted into right-handed circularly polarized light and emitted from the liquid crystal layer 30. In the present embodiment, the distance between the pixel electrode 20 and the common electrode 29 in the reflective area R is set larger than the distance between the pixel electrode 20 and the common electrode 21 in the transmissive area T, and the retardation of the liquid crystal layer 30 in the reflective area A is set to about half the retardation in the transmissive area T. Therefore, as described hereinabove, when the linearly polarized light passes through the liquid crystal layer 30, the light is converted into the circularly polarized light.

The right-handed circularly polarized light emitted from the liquid crystal layer 30 reaches a reflector (not shown in the figure) and is reflected, but in this case, the rotation direction, as viewed from polarizing plate 41 side, is reversed, left-handed circularly polarized light is obtained, and this light falls again on the liquid crystal layer 30. The left-handed circularly polarized light incident on the liquid crystal layer 30 is imparted with a predetermined retardation (λ/4) by the liquid crystal layer 30 in the reflective area R. As a result, the light is converted into linearly polarized light orthogonal to the transmission axis 41t of the polarizing plate 41 and reaches the polarizing plate 41. This linearly polarized light is absorbed by the polarizing plate 41 and the sub-pixels create a black display. Thus, the retardation of the liquid crystal display panel 100 in the reflective area R becomes λ/2 (twofold retardation λ/4 of the liquid crystal layer 30 in the reflective area R) and therefore a black display occurs in a parallel-Nicol state of one polarizing plate 41.

By contrast, when an image signal is applied, a voltage of 0 V is applied to the liquid crystal layer 30 in the reflective area R, as shown in Table 1 above, and no retardation is generated in the liquid crystal layer 30 in the reflective area R. Therefore, the linearly polarized light that is incident on the liquid crystal layer 30 and parallel to the transmission axis 41t of the polarizing plate 41 falls on the liquid crystal layer 30, while maintaining the same polarization state as at the time of incidence, and is reflected by the reflector (not shown in the figures). The reflected light then passes through the liquid crystal layer 30, then passes through the polarizing plate 41 and can be viewed. Thus, the sub-pixels create a white display. Accordingly, since the retardation of the liquid crystal display panel 100 in the reflective area R is 0 when an image signal is applied, a white display occurs in a parallel-Nicol state of one polarizing plate 41.

The results obtained in simulation measurements relating to the liquid crystal display device of the present embodiment will be described below.

First, merits of the liquid crystal display device of the present embodiment over the liquid crystal display device of the IPS system will be explained. The intensity of transmitted light in a mode in which the birefringence of a liquid crystal cell interposed between orthogonal polarizers is controlled by an electric field can be defined by the following Equation (1).

$$\begin{matrix}[ Equation ( 1 ) ] & \\ I = {I}_{0} \cdot {sin}^{2} 2 θ \cdot {sin}^{2} \frac{π \cdot d \cdot Δ n ( V )}{λ} & ( 1 )\end{matrix}$$

In Equation (1), I₀ stands for an intensity of incident polarized light, θ represents an angle formed by the oscillation directions of the incident polarized light and usual light in a liquid crystal cell, d represents a cell thickness (cell gap), Δn (V) represents a birefringence of the liquid crystal cell under a voltage V, d·Δn represents an optical retardation, and λ represents a wavelength of the incident light.

When the transmittance of a liquid crystal display panel is to be increased, the d·Δn value is set to increase the intensity of the transmitted light with λ of from 550 nm to 650 nm. However, since there is a light wavelength dispersivity in liquid crystals, the liquid crystals usually do not transmit the light uniformly in a range of λ of from 380 nm to 750 nm (visible light range).

The transmittance with respect to different wavelengths was simulation measured with respect to the TBA mode and IPS mode. The results obtained are explained below. FIG. 9 shows a transmitted light intensity (T)−voltage (V) characteristic at different wavelengths in the TEA-mode liquid crystal display device of Embodiment 1, the characteristic being determined by simulation. FIG. 9(a) shows the case in which d·Δn=447 nm and FIG. 9(b) shows the case in which d·Δn=497 nm. FIG. 10 shows a transmitted light intensity (T)−voltage (V) characteristic at different wavelengths in the IPS-mode liquid crystal display device of comparative example, the characteristic being determined by simulation. FIG. 10(a) shows the case in which d·Δn=318 nm and FIG. 10(b) shows the case in which d·Δn=348 nm.

The liquid crystal cell shown in FIG. 11 was used for simulation for both the TBA mode and the IPS mode. FIG. 11 is a perspective schematic diagram illustrating the configuration of sub-pixels used in the simulation (three-dimensional simulation). FIG. 12 is a graph showing a Δn-wavelength characteristic used in the simulation (three-dimensional simulation). As shown in FIG. 11, the liquid crystal cell used for the simulation includes the TFT substrate 10 having rectangular (in the planar view thereof) electrodes 61, 62 that are provided opposite and parallel to each other, the counter substrate 50, and the liquid crystal layer 30 interposed between the TFT substrate 10 and the counter substrate 50. The polarizers are set in a cross-Nicol state. The smaller is the width (L) of the electrodes 61, 62, the better is the transmittance. Therefore, the width was set to 1.5 μm, which is the minimum value of the presently used process. The distance (S) between the electrodes 61, 62 was set to 7.5 μm. Thus, L/S was set to 1.5 μm/7.5 μm. The dielectric anisotropy (Δ∈) of the liquid crystal layer was set to 20. Further, I₀ was set to 1 and θ was set to 45°. The simulation was conducted with respect to wavelengths of 450 nm, 550 nm, and 650 nm. Other simulations described hereinbelow were conducted under similar conditions, unless specifically stated otherwise.

The results demonstrate that in the IPS mode, where d·Δn is increased from 318 nm to 348 nm, the Y value under an applied voltage of 6.5 V increases from 547 to 553 and the display clearly becomes lighter. However, the comparison of FIGS. 10(a) and (b) shows that the transmittance at a wavelength of 450 nm under a high applied voltage is substantially lower than the transmittance at other wavelengths. Therefore, in the IPS mode, a white display with a low color temperature that has a blue color loss is easily obtained. The VA mode demonstrates the same trend as the IPS mode.

By contrast, in the TBA mode, where d·Δn is increased from 447 nm to 497 nm, the Y value under an applied voltage of 6.5 V increases from 451 to 459 and the display becomes lighter. The comparison of FIGS. 9(a) and (b) demonstrates that the decrease in transmittance at a wavelength of 450 nm under a high applied voltages with respect to transmittance at other wavelengths is small. Therefore, in the TBA mode, a white display with a high color temperature, which is low in blue color loss, can be easily obtained.

When the transmittance is thus increased by increasing the d·Δn value, the transmitted light intensity at λ=380 to 750 nm (visible range) in the TBA mode can be increased more uniformly than in the IPS mode.

Further, in the TBA mode, the transmitted light intensity can be increased more uniformly by adjusting the distance (S) between the electrodes 61, 62. FIG. 13 shows a transmitted light intensity (T)-voltage (V) characteristic at different wavelengths in the TBA-mode liquid crystal display device of Embodiment 1, the characteristic being determined by simulation. FIG. 13(a) shows the case in which d·Δn=447 nm and FIG. 13(b) shows the case in which d·Δn=497 nm. FIGS. 13(a) and (b) both show the results obtained when L/S is 1.5 μm/10 μm.

The comparison of FIGS. 9 and 13 demonstrates that where the distance (S) between the electrodes 61, 62 is increased, the electric field intensity decreases, and therefore the T−V characteristic shifts to a high voltage side. Further, the decrease in transmittance at a wavelength of 450 nm under a high applied voltage with respect to transmittance at other wavelengths can be further decreased with respect to that in the case in which L/S is 1.5 μm/7.5 μm. Thus, in the TBA mode, the transmitted light intensity can be increased more uniformly by increasing the distance (S) between the electrodes 61, 62.

The above-described results demonstrate that when the liquid crystal display device of the present embodiment uses the same driver as that of the conventional VA-mode (for example, the ASV mode in which liquid crystal molecules are aligned radially, the protrusion provided at the counter substrate serving as a center) transflective type liquid crystal display device, the ideal L/S value in the transmissive area T is 1.5 μm/(7.5 to 10) μm. Thus, in this case, the ideal L/S value in the transmissive area T is obtained when S=7.5 to 10 μm with respect to L=1.5 μm. By contrast, when much importance is attached to the response time, the L/S value in the transmissive area T is preferably set to 1.5 μm/(4 to 7.5) μm. Thus, in this case the preferred L/S value in the transmissive area T is obtained when S=4 to 7.5 μm with respect to L=1.5 μm. However, in this case, a driver that is different from that of the conventional VA mode should be used.

A reflective display characteristic of the liquid crystal display device of the present embodiment will be described below. A transmitted light intensity in a mode in which birefringence of a liquid crystal cell interposed between the parallel polarizers is controlled by an electric field can be generally represented by the following Equation (2). Thus, the reflected light intensity also can be represented by Equation (2) below.

$$\begin{matrix}[ Equation ( 2 ) ] & \\ I = {I}_{0} \cdot {sin}^{2} 2 θ \cdot {cos}^{2} \frac{π \cdot d \cdot Δ n ( V )}{λ} & ( 2 )\end{matrix}$$

In Equation (2), I₀ stands for an intensity of incident polarized light, θ represents an angle formed by the oscillation directions of the incident polarized light and usual light in a liquid crystal cell, d represents a cell thickness (cell gap), Δn (V) represents a birefringence of the liquid crystal cell under a voltage V, d·Δn represents an optical retardation, and λ represents a wavelength of the incident light. Thus, the transmitted light intensity is represented by an equation that differs depending on whether the polarizers are orthogonal or parallel.

Firstly, the results will be explained that were obtained by conducting simulation measurements of a transmission characteristic and a reflection characteristic in a state with a parallel arrangement of polarizers in a TBA-mode liquid crystal display device of a comparative example. FIG. 14 is a cross-sectional schematic diagram illustrating the configuration of sub-pixels used in the simulation (three-dimensional simulation). In this case, L/S was set to 1.5 μm/10 μm and d·Δn was set to 447 nm. Thus, in this case, the L/S value of the reflective area R was set to the L/S value of the transmissive area T at which good transmissive display has been realized, on the basis of results shown in FIGS. 9 and 13. When the reflective characteristic was determined, the simulation was conducted by setting the reflectance of the reflector to 100%. FIG. 15 shows an optical retardation (d·Δn)−voltage (V) characteristic during transmission in points at a distance of 0 μm, 1.25 μm, and 2 μm from the electrode edge in a TBA-mode liquid crystal display device of a comparative example, the characteristic being determined by simulation. FIG. 16 shows an optical retardation (d·Δn)−voltage (V) characteristic during reflection in points at a distance of 0 μm, 1.25 μm, and 2 μm from the electrode edge in a TBA-mode liquid crystal display device of a comparative example, the characteristic being determined by simulation. FIG. 17 shows a transmitted light intensity (T)−voltage (V) characteristic during transmission in a TBA-mode liquid crystal display device of a comparative example, the characteristic being determined by simulation. FIG. 17(a) shows the result in a point at a distance of 0 μm from the electrode edge. FIG. 17(b) shows the result in a point at a distance of 1.25 μm from the electrode edge. FIG. 17(c) shows the result in a point at a distance of 2 λm from the electrode edge. FIG. 18 shows a reflected light intensity (R)−voltage (V) characteristic during reflection in a TBA-mode liquid crystal display device of a comparative example, the characteristic being determined by simulation. FIG. 18(a) shows the result in a point at a distance of 0 μm from the electrode edge. FIG. 18(b) shows the result in a point at a distance of 1.25 μm from the electrode edge. FIG. 18(c) shows the result in a point at a distance of 2 μm from the electrode edge. FIG. 19 shows a graph obtained by averaging the transmitted light intensity (T)−voltage (V) characteristic during transmission in points at a distance of 0 μm, 1.25 μm, and 2 μm from the electrode edge in a TBA-mode liquid crystal display device of a comparative example, the characteristic being determined by simulation. FIG. 20 shows a graph obtained by averaging the reflected light intensity (R)−voltage (V) characteristic during reflection in points at a distance of 0 μm, 1.25 μm, and 2 μm from the electrode edge in a TEA-mode liquid crystal display device of a comparative example, the characteristic being determined by simulation. FIGS. 15 to 20 show the simulation results obtained without disposing a quarter-wave plate.

These figures demonstrate that when the L/S value of the reflective area R is set in the same manner as in the transmissive area T, that is, the distance S between the electrodes in the reflective area R is set to the same value as the distance S between the electrodes in the transmissive area T at which good transmissive display has been realized, short-wavelength light leaks when a high voltage is applied and a sufficient reflective characteristic is not obtained.

Since the optical retardation d·Δn differs among the points when the voltage is applied and the results obtained in the transmissive area T and the reflective area R differ depending on whether the polarizers are orthogonal or parallel, the white display and black display are not reversed symmetrically in the transmissive area T and the reflective area R.

Secondly, the results will be explained that were obtained by conducting simulation measurements of a reflection characteristic in a state with a parallel arrangement of polarizers in the TBA-mode liquid crystal display device the present embodiment. FIG. 21 is a cross-sectional schematic diagram illustrating the configuration of sub-pixels used in the simulation (three-dimensional simulation). The following settings were used in this case: L/S=1.5 μm/13 μm and d·Δn=447 nm. Thus, in this case, the distance S between the electrodes in the reflective area R was enlarged with respect to the distance S between the electrodes in the transmissive area T at which good transmissive display has been realized. The simulation was conducted by setting the reflectance of the reflector to 100%. FIG. 22 shows an optical retardation (d·Δn)−voltage (V) characteristic during reflection in points at a distance of 0 μm, 1.625 μm, and 3.25 μm from the electrode edge in the TBA-mode liquid crystal display device according to Embodiment 1, the characteristic being determined by simulation. FIG. 23 shows a reflected light intensity (R)−voltage (V) characteristic during reflection in the TEA-mode liquid crystal display device according to Embodiment 1, the characteristic being determined by simulation. FIG. 23(a) shows the result in a point at a distance of 0 μm from the electrode edge. FIG. 23(b) shows the result in a point at a distance of 1.625 μm from the electrode edge. FIG. 23(c) shows the result in a point at a distance of 3.25 μm from the electrode edge. FIG. 24 shows a graph obtained by averaging the reflected light intensity (R)−voltage (V) characteristic during reflection in points at a distance of 0 μm, 1.625 μm, and 3.25 μm from the electrode edge in the TEA-mode liquid crystal display device according to Embodiment 1, the characteristic being determined by simulation. FIGS. 22 to 24 show the simulation results obtained without disposing a quarter-wave plate. FIG. 21 shows a graph obtained by averaging the reflected light intensity (R)−voltage (V) characteristic of the TEA-mode liquid crystal display device according to Embodiment 1 in the case in which a quarter-wave plate is disposed on the counter substrate side, the characteristic being determined by simulation.

As shown in the figures, where the space between the electrodes 61, 62 is increased from 10 μm to 13 μm, the optical retardation d·Δn and reflected light intensity (R)−voltage (V) characteristic change significantly. A sufficient reflective characteristic can be obtained by setting the distance S between the electrodes in the reflective area A larger than the distance S between the electrodes in the transmissive area T. Further, since the averaged reflected light intensity (R)−voltage (V) characteristic is taken by the human eyes, the liquid crystal display device of the present embodiment makes it possible to recognize uniform light over a range from a short wavelength to a long wavelength, as shown in FIG. 24. Further, in the TEA-mode liquid crystal display device of the present embodiment, the optical retardation d·Δn also differs among the points when the voltage is applied and the results obtained in the transmissive area T and the reflective area R also differ depending on whether the polarizers are orthogonal or parallel. Therefore, the white display and black display are not reversed symmetrically in the transmissive area T and the reflective area R.

With the liquid crystal display device of the present embodiment, the reflective display and transmissive display of excellent quality can be obtained in the TBA mode, without providing a multigap structure and a quarter-wave plate. Further, since it is not necessary to provide a concavoconvex structure on the counter substrate side or a quarter-wave plate on the main exterior surface of the liquid crystal display panel as in the conventional transflective type liquid crystal display device having the multigap structure, the cost can be reduced and a contrast characteristic in the transmissive display can be improved. Further, since it is not necessary to provide transparent electrode or ribs (protrusions for controlling an alignment) on the counter substrate side as in the conventional VA-mode transflective type liquid crystal display device, the cost can be reduced by comparison with that of the conventional VA-mode transflective type liquid crystal display device.

The present application claims priority under the Paris Convention and the domestic law in the country to be entered into national phase to Japanese Patent Application No. 2008-125199, filed on May 12, 2008, the entire contents of which are hereby incorporated by reference into this application.

### BRIEF DESCRIPTION OF THE DRAWINGS

FIG. 1 is a plan schematic view illustrating the configuration of a liquid crystal display panel of Embodiment 1.

FIG. 2(a) is a plan schematic view illustrating the configuration of one sup-pixel of the liquid crystal display panel of Embodiment 1, and FIG. 2(b) is a schematic diagram illustrating the mutual arrangement of transmission axes of polarizing plates in Embodiment 1.

FIG. 3 is a schematic cross-sectional view illustrating the configuration of the liquid crystal display panel of Embodiment 1, this view showing a cross section taken along line X-Y in FIG. 2(a).

FIG. 4 is a plan schematic view illustrating a circuit configuration of the liquid crystal display device of Embodiment 1.

FIG. 5 is a schematic cross-sectional view illustrating the alignment distribution of liquid crystals when a voltage is applied to the liquid crystal display panel of Embodiment 1, and um means μm in FIG. 5.

FIG. 6 is a timing chart of the liquid crystal display device of Embodiment 1, FIG. 6(a) showing a state in which an image signal is not applied (black display) and FIG. 6(b) showing a state in which an image signal is applied (white display).

FIG. 7 is a cross-sectional schematic view illustrating the configuration of the liquid crystal display device of Embodiment 1 and the relationship of retardation, FIG. 7(a) illustrating the case in which no voltage is applied, and FIG. 7(b) illustrating the case in which a voltage is applied.

FIG. 8 shows an ideal transmitted light intensity (T)−voltage (V) characteristic of the liquid crystal display device of Embodiment 1.

FIG. 9 shows a transmitted light intensity (T)−voltage (V) characteristic at different wavelengths in the TEA-mode liquid crystal display device of Embodiment 1, the characteristic being determined by simulation, FIG. 9(a) showing the case in which d·Δn=447 nm and FIG. 9(b) showing the case in which d·Δn=497 nm.

FIG. 10 shows a transmitted light intensity (T)−voltage (V) characteristic at different wavelengths of a liquid crystal display device of an IPS mode that is a comparison example, the characteristic being found by simulation, FIG. 10(a) showing the case in which d·Δn=318 nm and FIG. 10(b) showing the case in which d·Δn=348 nm.

FIG. 11 is a perspective schematic diagram illustrating the configuration of sub-pixels used in simulation (three-dimensional simulation).

FIG. 12 is a graph illustrating a Δn-wavelength characteristic of a liquid crystal used in simulation (three-dimensional simulation).

FIG. 13 shows a transmitted light intensity (T)−voltage (V) characteristic at different wavelengths of a liquid crystal display device of a TBA mode according to Embodiment 1, the characteristic being found by simulation, FIG. 13(a) showing the case in which d·Δn=447 nm and FIG. 13(h) showing the case in which d·Δn=497 nm.

FIG. 14 is a cross-sectional schematic diagram illustrating the configuration of sub-pixels used in the simulation (three-dimensional simulation).

FIG. 15 shows an optical retardation (d·Δn)−voltage (V) characteristic during transmission in points at a distance of 0 μm, 1.25 μm, and 2 μm from the electrode edge in a TBA-mode liquid crystal display device of a comparative example, the characteristic being determined by simulation.

FIG. 16 shows an optical retardation (d·Δn)−voltage (V) characteristic during reflection in points at a distance of 0 μm, 1.25 μm, and 2 μm from the electrode edge in a TBA-mode liquid crystal display device of a comparative example, the characteristic being determined by simulation.

FIG. 17 shows a transmitted light intensity (T)−voltage (V) characteristic during transmission in a TBA-mode liquid crystal display device of a comparative example, the characteristic being determined by simulation, FIG. 17(a) showing the result in a point at a distance of 0 μm from the electrode edge, FIG. 17(b) showing the result in a point at a distance of 1.25 μm from the electrode edge, and FIG. 17(c) showing the result in a point at a distance of 2 μm from the electrode edge.

FIG. 18 shows a reflected light intensity (R)−voltage (V) characteristic during reflection in a TBA-mode liquid crystal display device of a comparative example, the characteristic being determined by simulation, FTG. 18(a) showing the result in a point at a distance of 0 μm from the electrode edge, FIG. 18(b) showing the result in a point at a distance of 1.25 μm from the electrode edge, and FIG. 18(c) showing the result in a point at a distance of 2 μm from the electrode edge.

FIG. 19 shows a graph obtained by averaging the transmitted light intensity (T)−voltage (V) characteristic during transmission in points at a distance of 0 μm, 1.25 μm, and 2 μm from the electrode edge in a TBA-mode liquid crystal display device of a comparative example, the characteristic being determined by simulation.

FIG. 20 shows a graph obtained by averaging the reflected light intensity (R)−voltage (V) characteristic during reflection in points at a distance of 0 μm, 1.25 μm, and 2 μm from the electrode edge in a TBA-mode liquid crystal display device of a comparative example, the characteristic being determined by simulation.

FIG. 21 is a cross-sectional schematic diagram illustrating the configuration of sub-pixels used in the simulation (three-dimensional simulation).

FIG. 22 shows an optical retardation (d·Δn)−voltage (V) characteristic during reflection in points at a distance of 0 μm, 1.625 μm, and 3.25 μm from the electrode edge in a TBA-mode liquid crystal display device according to Embodiment 1, the characteristic being determined by simulation.

FIG. 23 shows a reflected light intensity (R)−voltage (V) characteristic during reflection in a TBA-mode liquid crystal display device according to Embodiment 1, the characteristic being determined by simulation, FIG. 23(a) showing the result in a point at a distance of 0 μm from the electrode edge, FIG. 23(b) showing the result in a point at a distance of 1.625 μm from the electrode edge, and FIG. 23(c) showing the result in a point at a distance of 3.25 μm from the electrode edge.

FIG. 24 shows a graph obtained by averaging the reflected light intensity (R)−voltage (V) characteristic during reflection in points at a distance of 0 μm, 1.625 μm, and 3.25 μm from the electrode edge in the TBA-mode liquid crystal display device according to Embodiment 1, the characteristic being determined by simulation.

FIG. 25 is a schematic plan view illustrating the configuration of a liquid crystal display panel of Comparative Example 1.

FIG. 26 is a schematic plan view illustrating the configuration of a liquid crystal display panel of Comparative Example 2.

FIG. 27 shows a transmitted light intensity (T)−voltage (V) characteristic of a TEA-mode liquid crystal display panel according to a Comparative Examples 1 and 2.

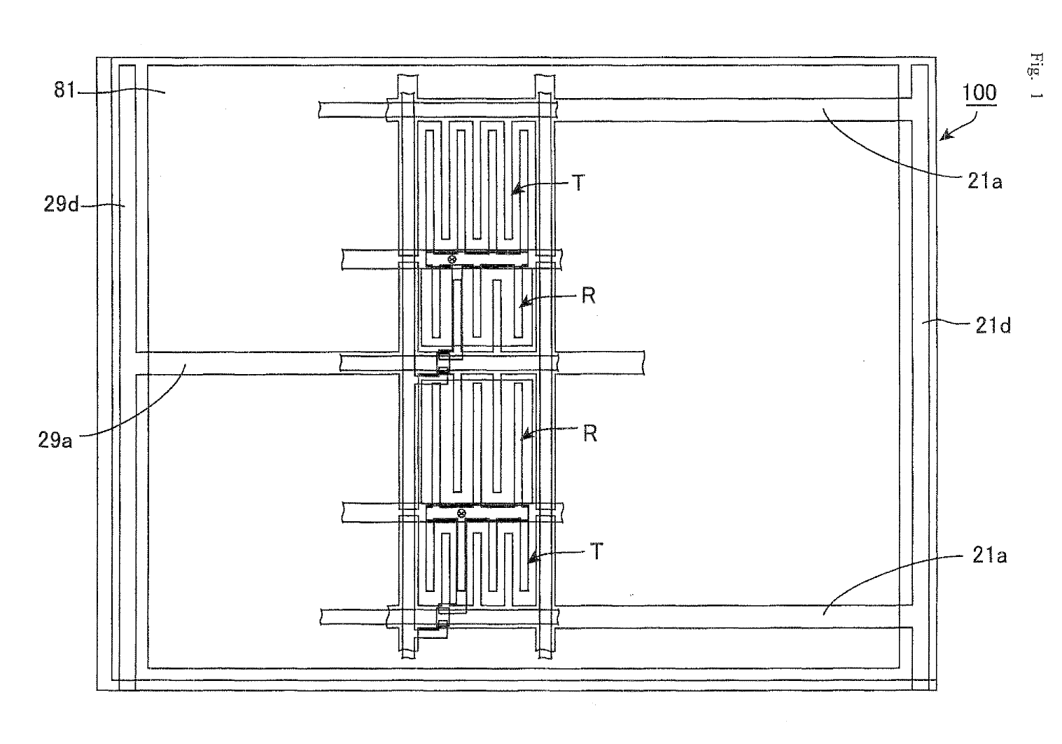

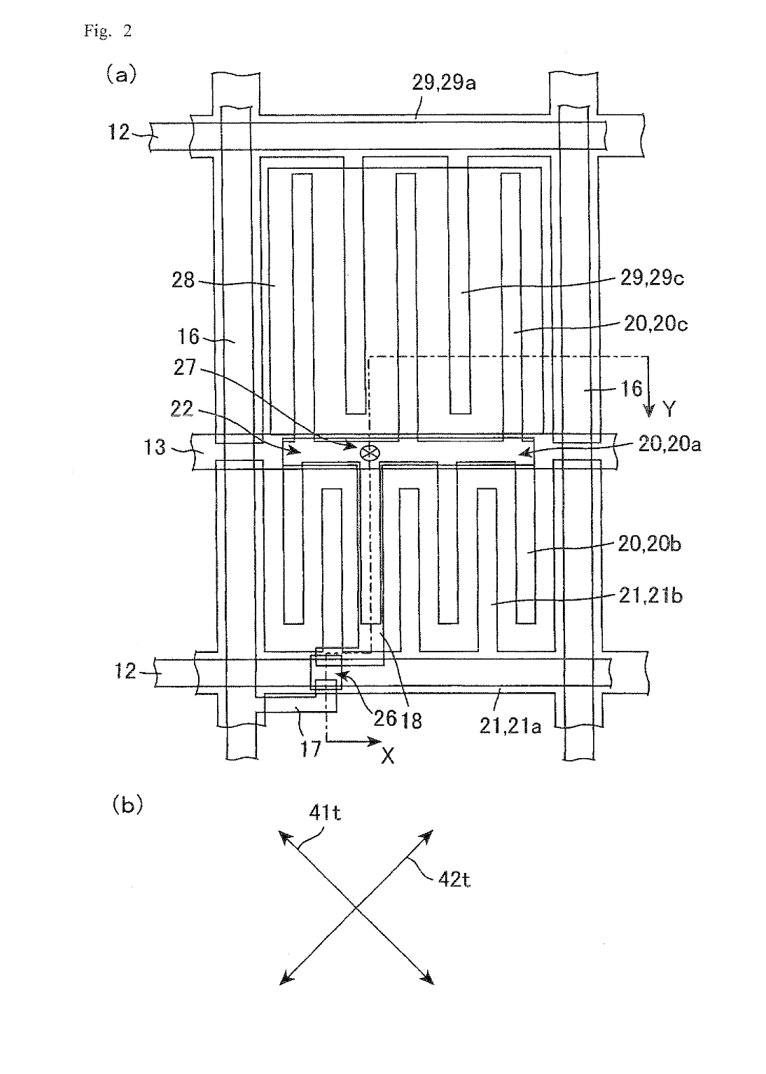

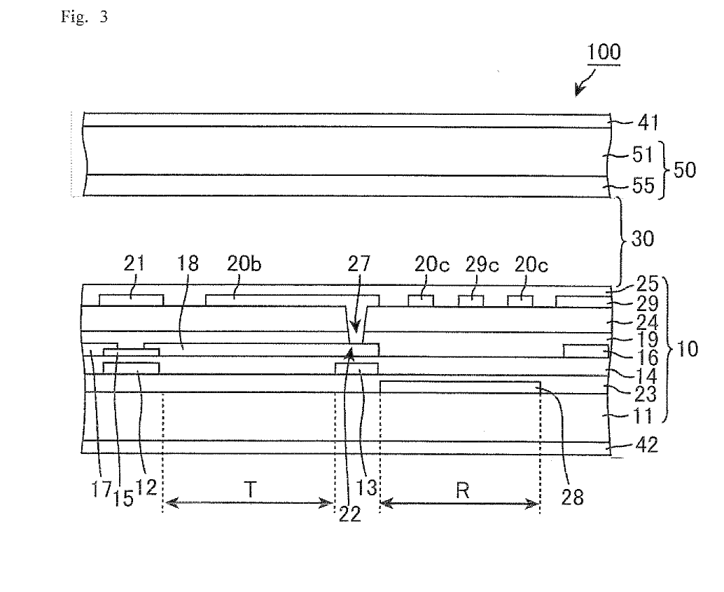

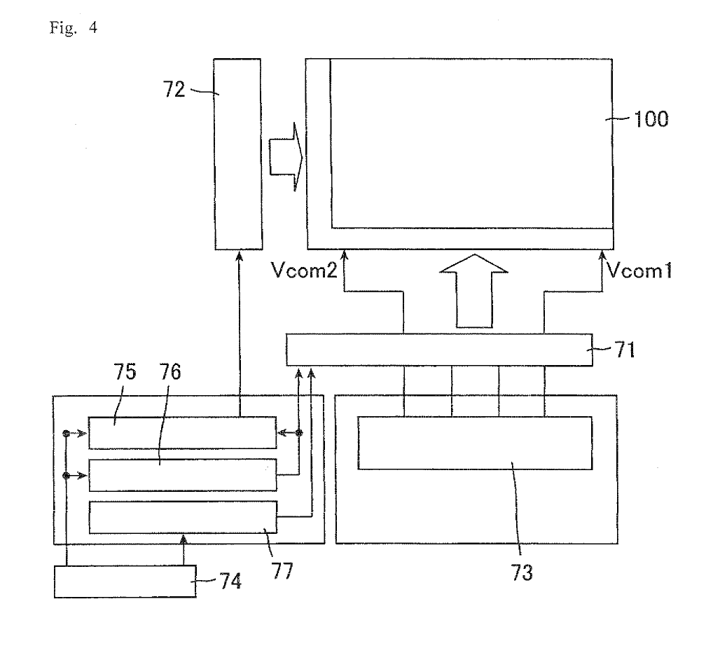

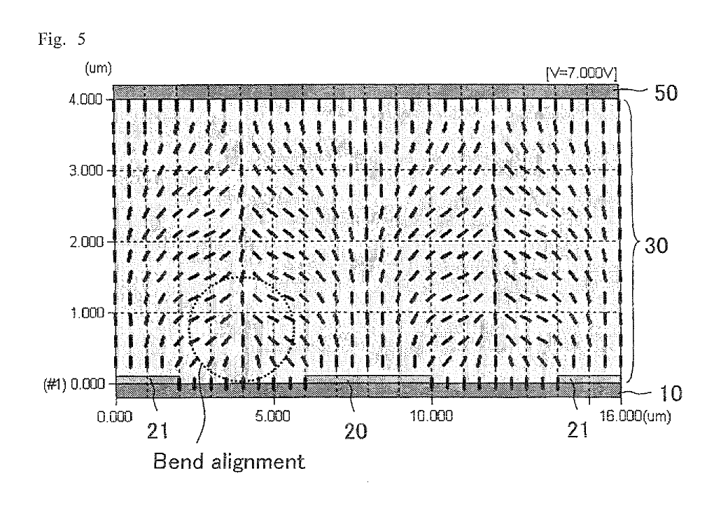

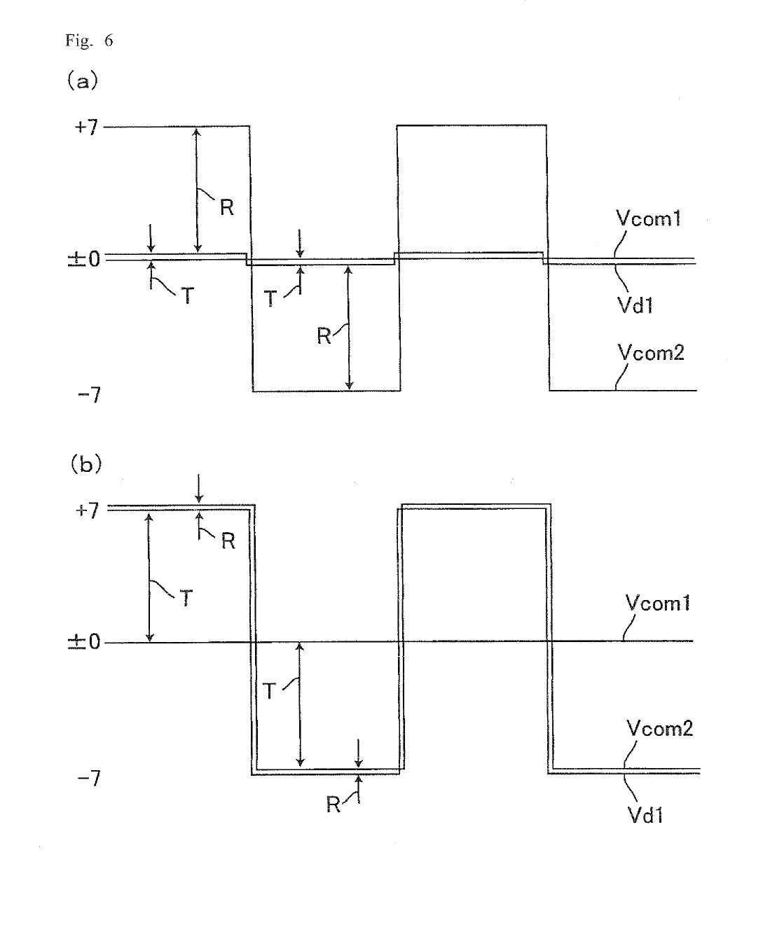

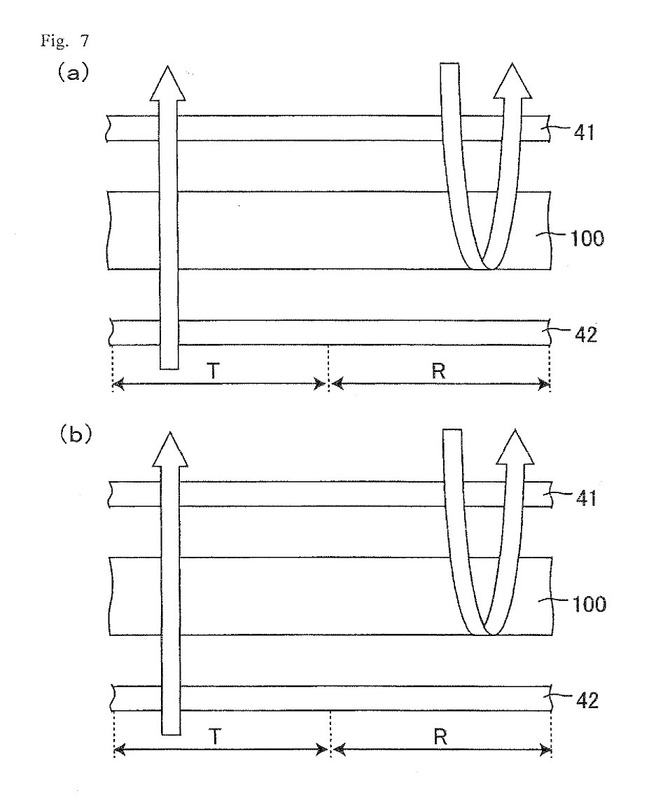

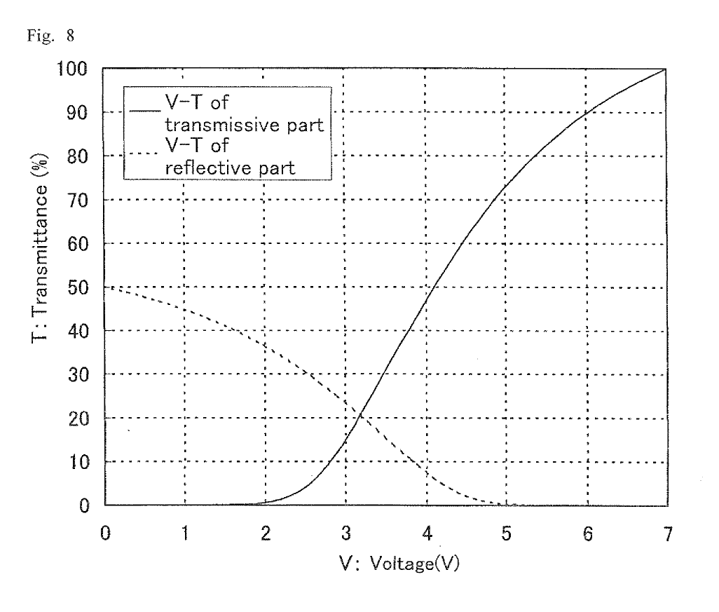

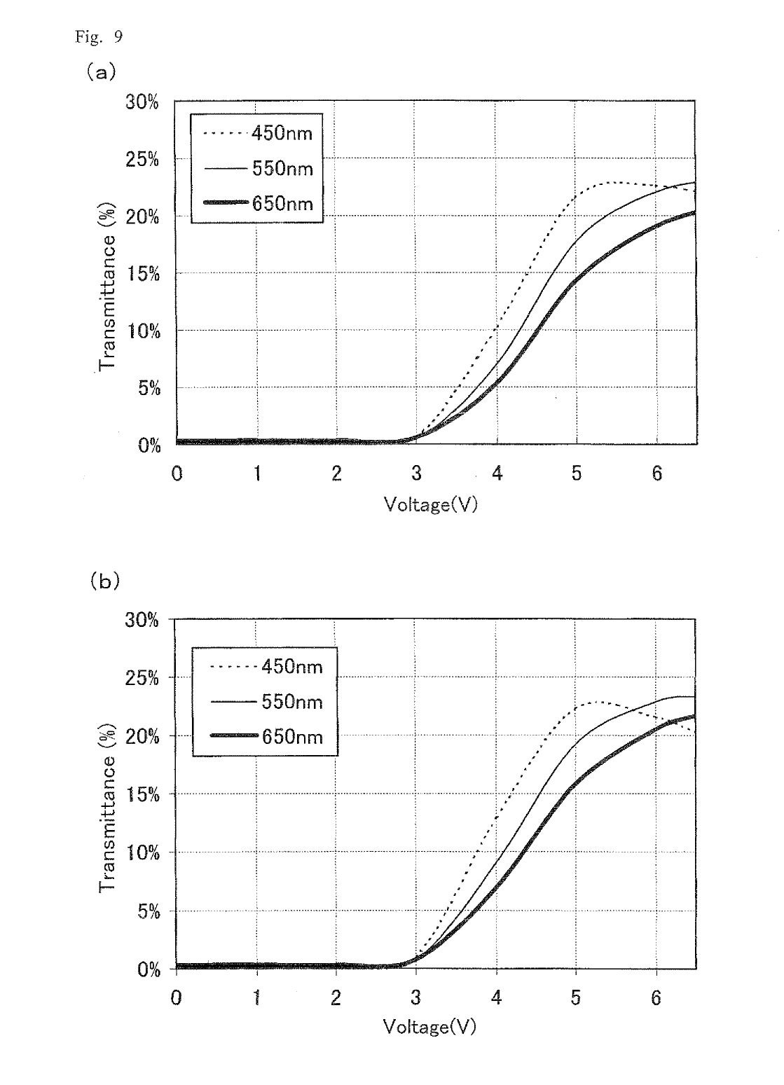

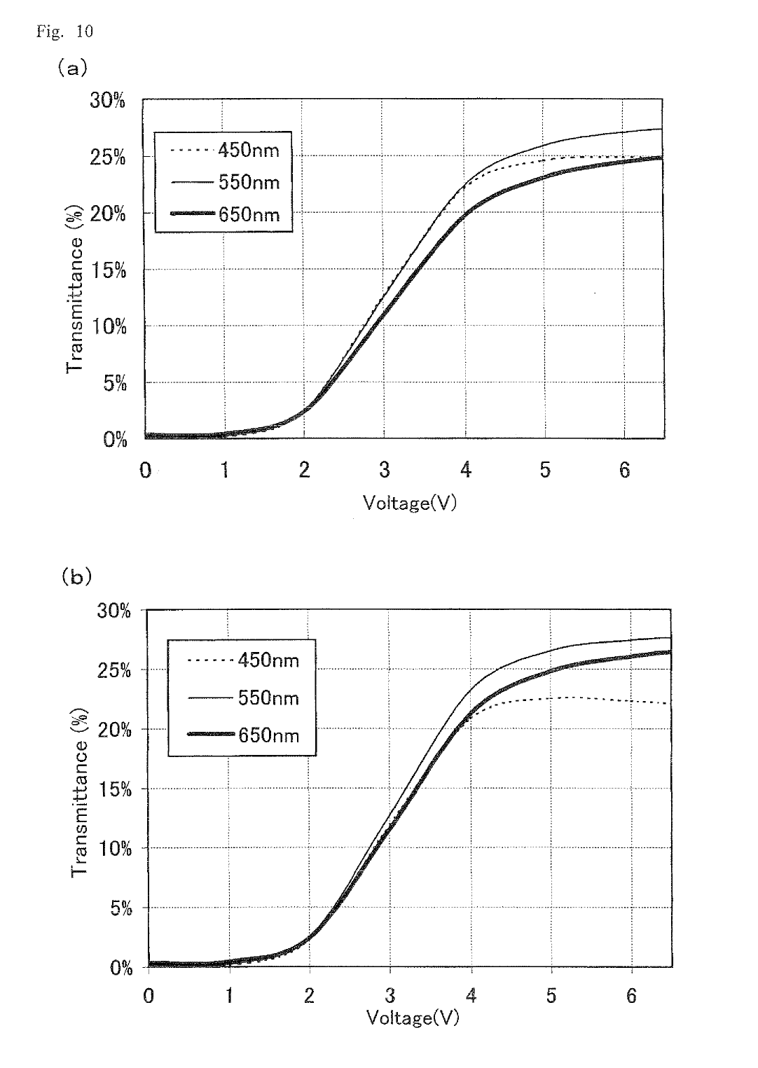

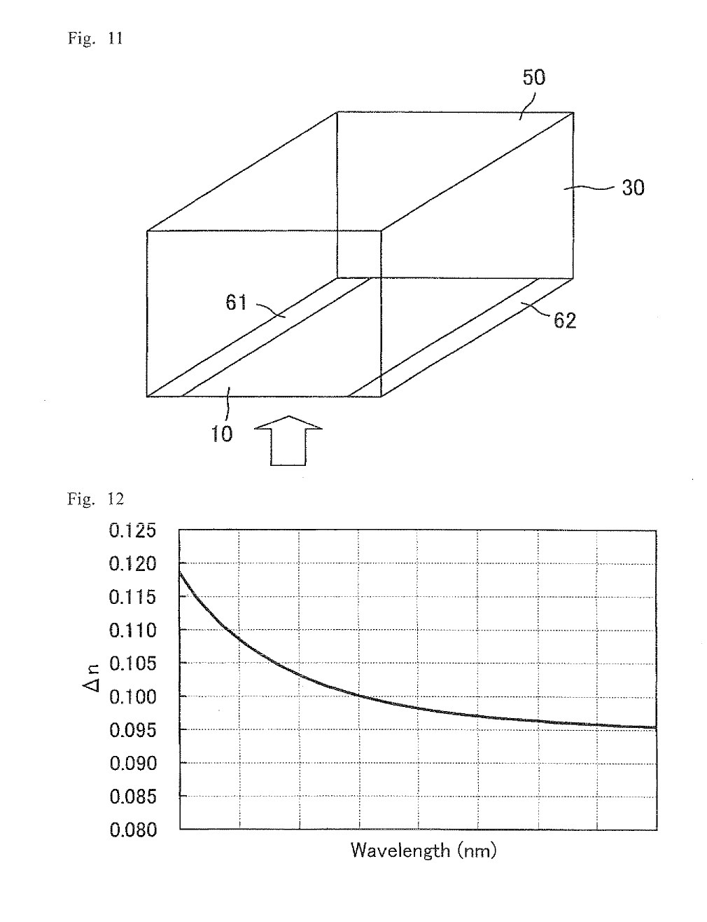

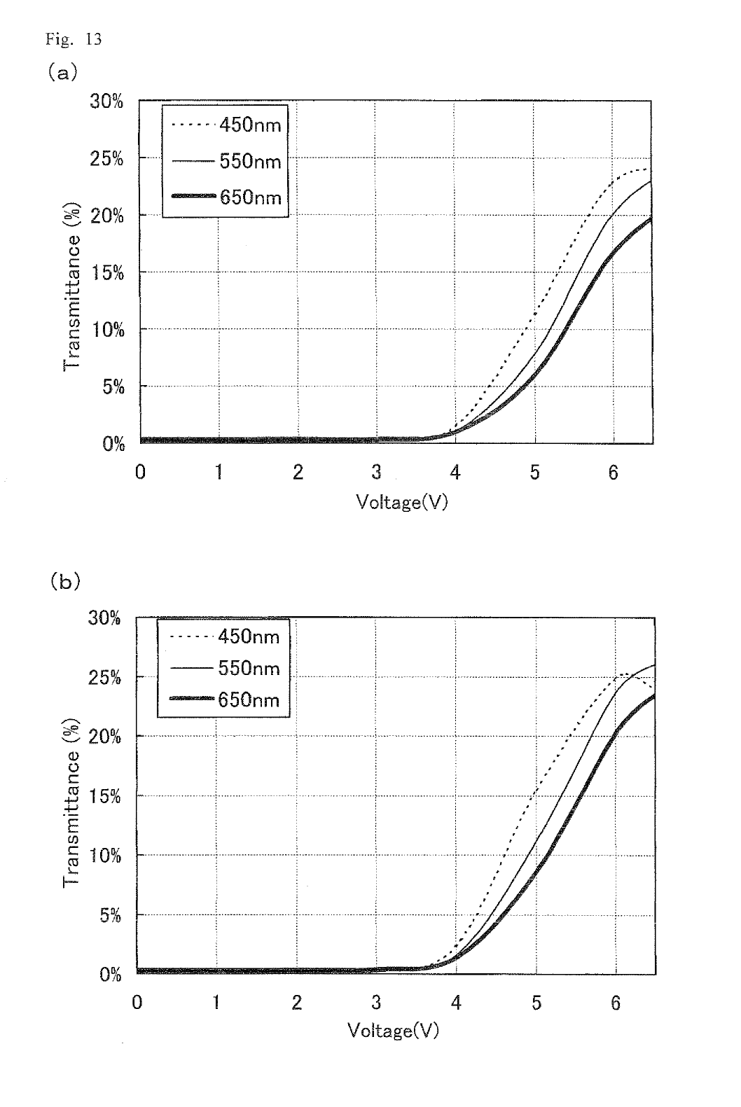

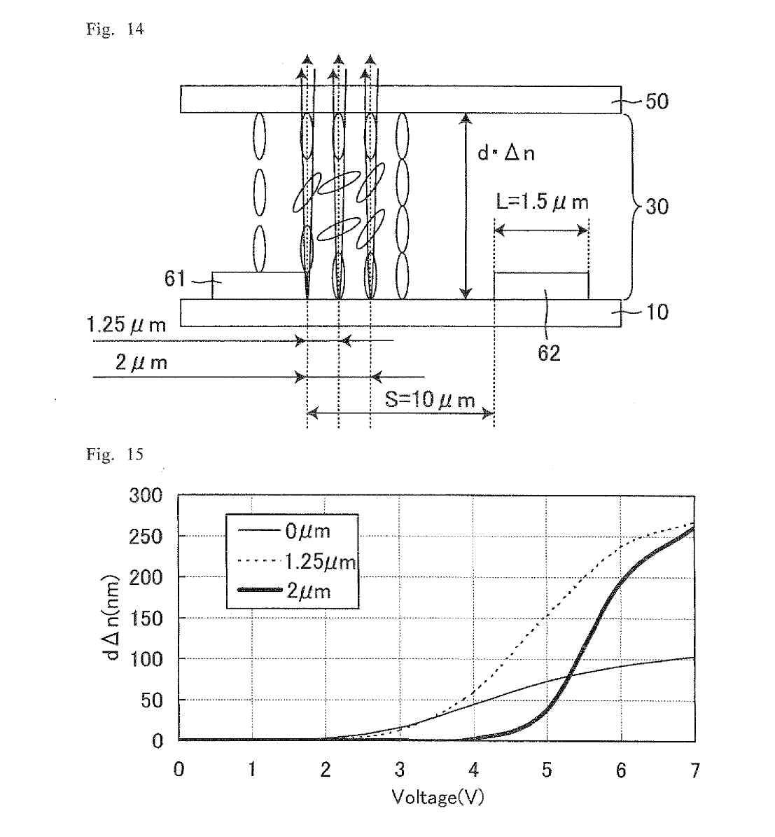

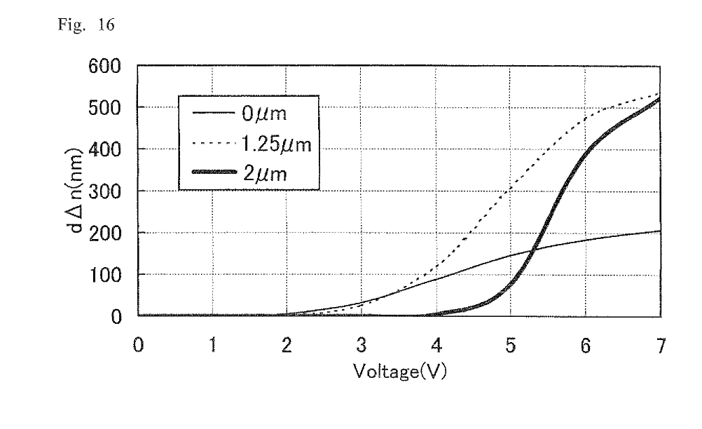

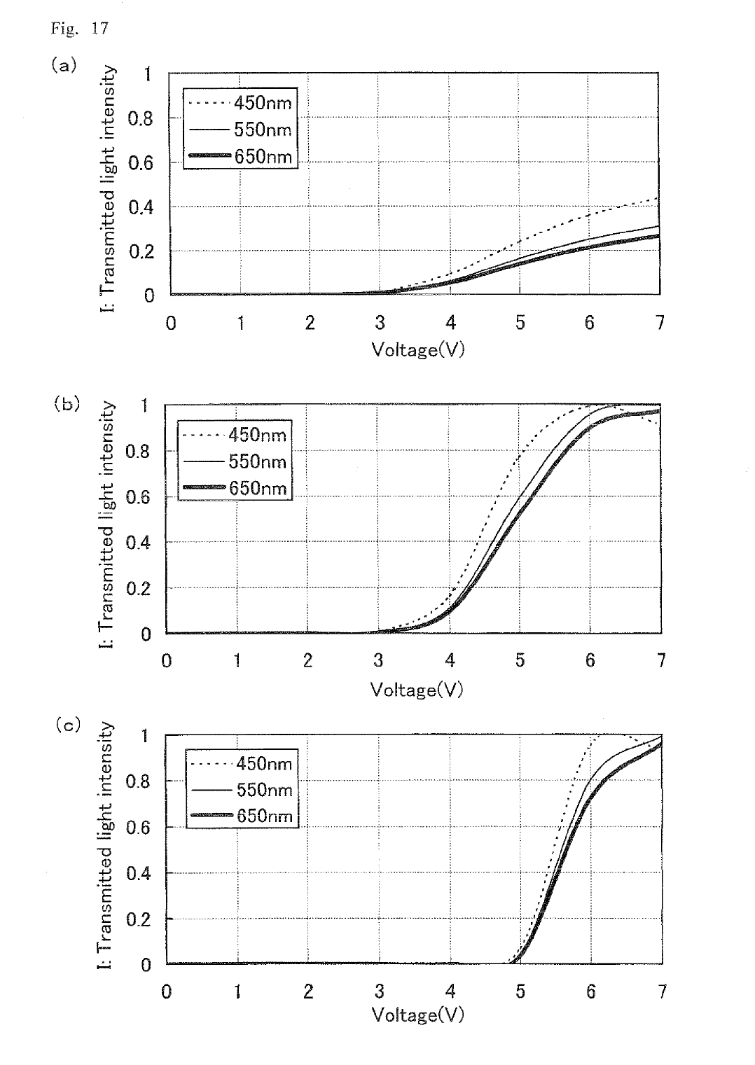

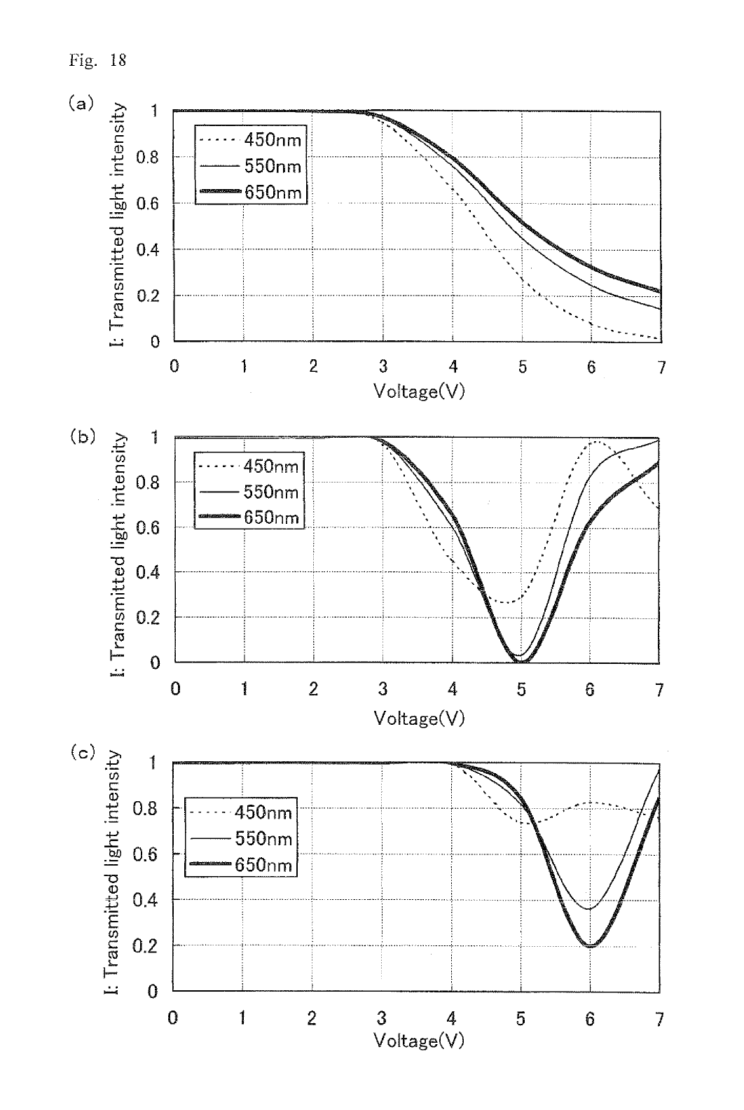

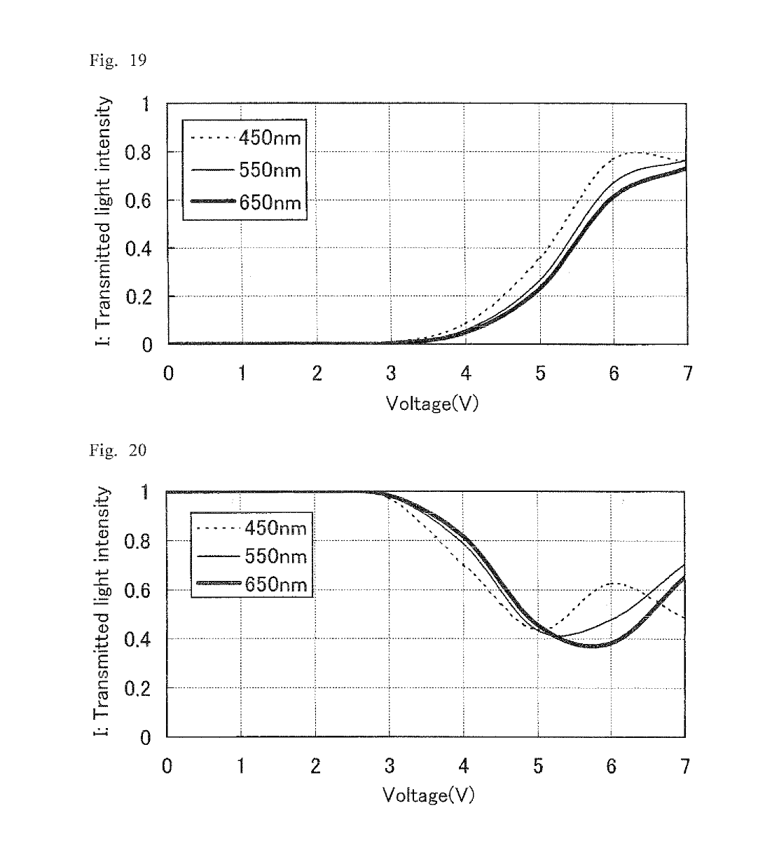

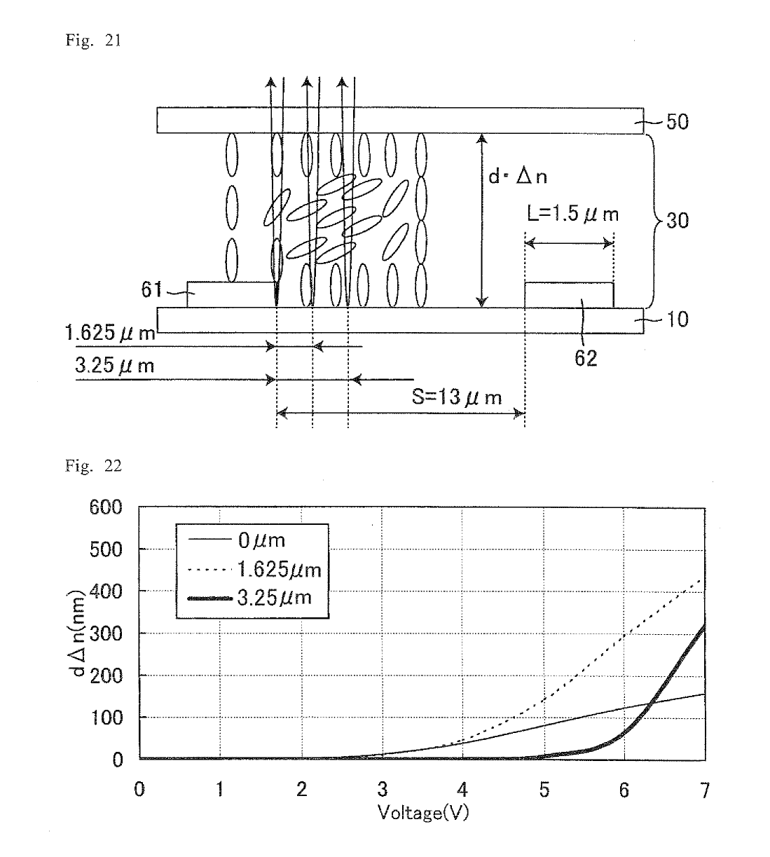

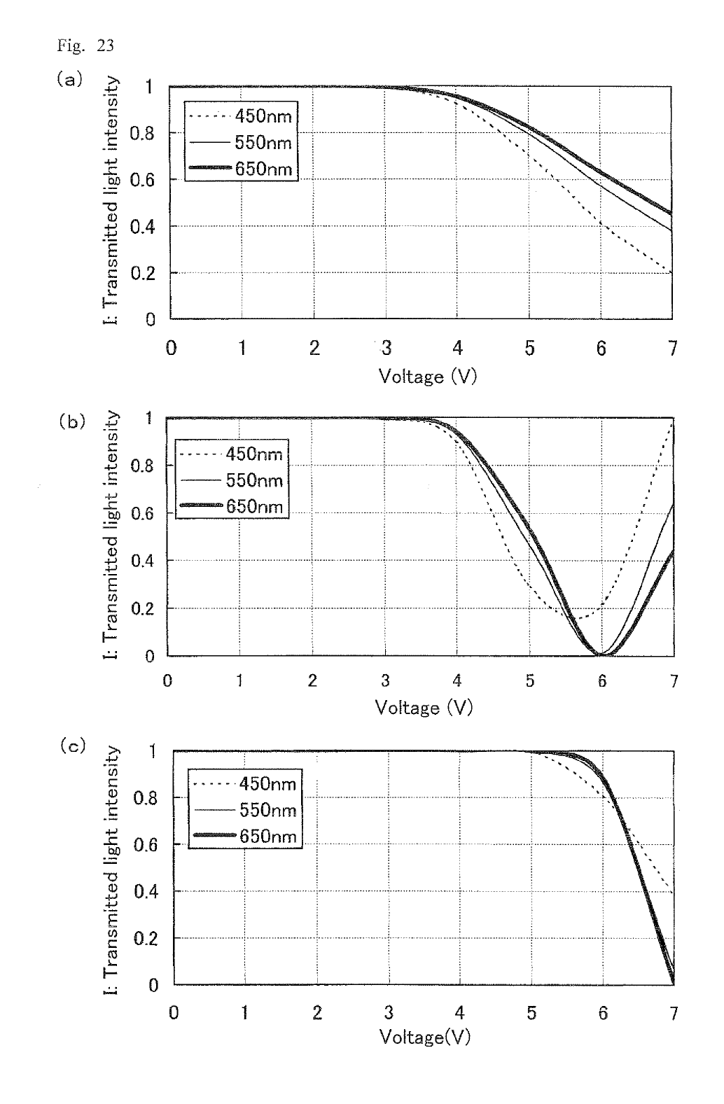

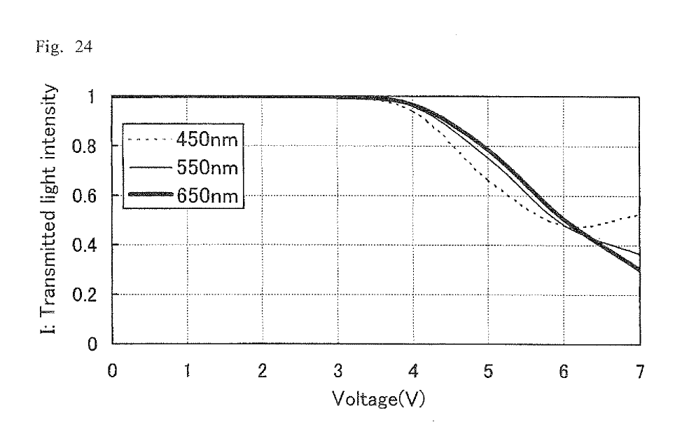

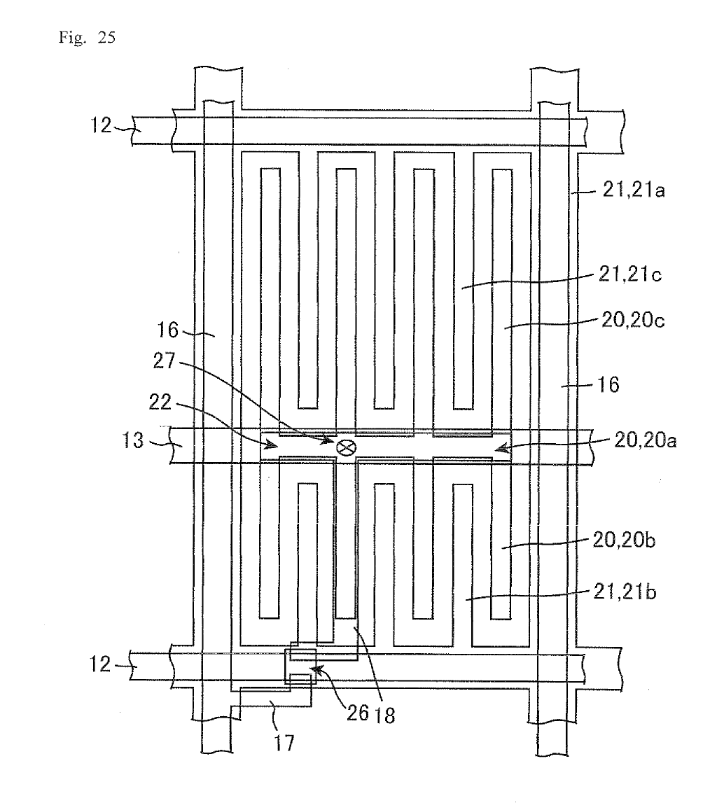

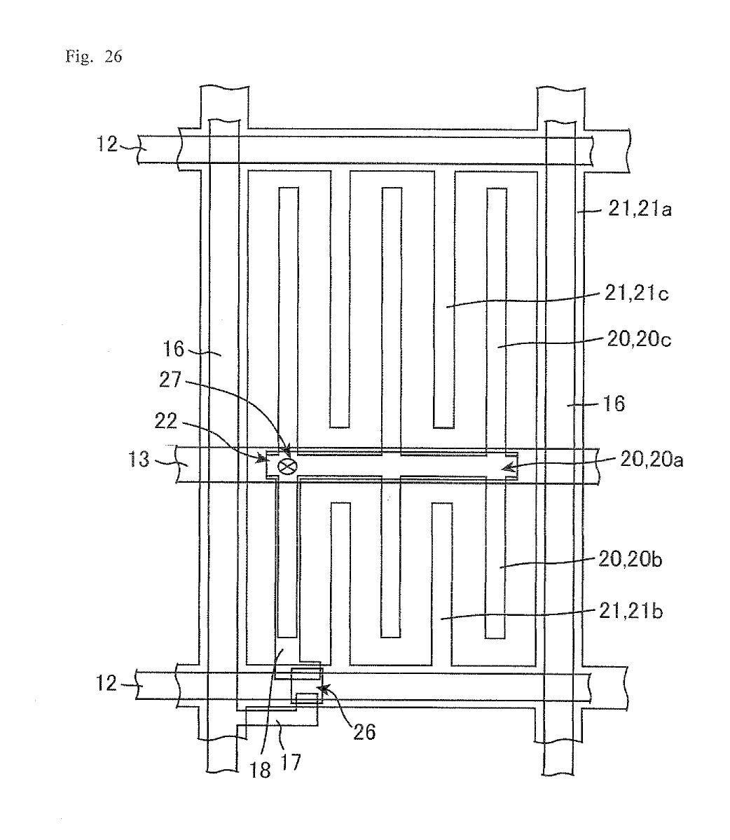

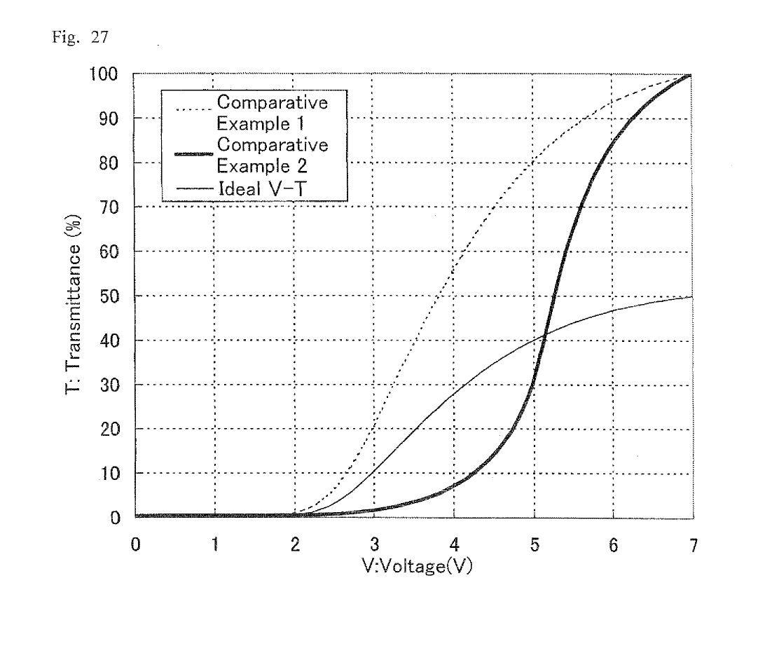

### EXPLANATION OF SYMBOLS

10: active matrix substrate
11: insulating substrate
12: gate bus line
13: Cs bus line (capacitance storage line)
14: gate insulator
15: semiconductor layer
16: source bus line
17: source line
18: drain line
19: interlayer insulating film
20: pixel electrode
21, 29: common electrode
20a, 21a, 29a: trunk portion
20b, 20c, 21b, 21c, 29c: branch portion
21d, 29d: base trunk portion
22: storage capacitance portion
23: interlayer insulating film
24: planarizing film
25: vertical alignment film
26: thin film transistor (TFT)
27: contact hole
28: reflective layer
30: liquid crystal layer
41, 42: polarizing plate
41t, 42t: transmission axis of polarizing plate
43, 44: retarder
43s, 44s: slow axis of retarder
50: counter substrate
51: insulating substrate
55: vertical alignment film
61, 62: electrode
71: source driver (data line drive circuit)
72: gate driver (scanning line drive circuit)
73: gradation reference voltage generating circuit
74: external signal source
75: vertical timing control circuit
76: horizontal timing control circuit
77: image data conversion circuit
81: display area (image display area)
100: liquid crystal display panel
T: transmissive area
R: reflective area
Vd1: image signal
Vcom1: constant voltage (black gradation voltage)
Vcom2: white gradation voltage

1. A liquid crystal display device, comprising:
a first substrate and a second substrate that are disposed opposite each other; and
a liquid crystal layer that is interposed between the first substrate and the second substrate, and having, in a pixel area, a reflective area where reflective display is performed and a transmissive area where transmissive display is performed,
wherein the first substrate has a first electrode provided in the transmissive area and the reflective area, a second electrode provided in the transmissive area and disposed parallel to and opposite the first electrode inside the pixel area, and a third electrode provided in the reflective area and disposed parallel to and opposite the first electrode inside the pixel area,
the liquid crystal layer includes a p-type nematic liquid crystal and is driven by an electric field generated at least one of between the first electrode and the second electrode and between the first electrode and the third electrode,
the p-type nematic liquid crystal is aligned perpendicular to the first substrate and the second substrate when no voltage is applied,
a distance between the first electrode and the third electrode is different from a distance between the first electrode and the second electrode, and
mutually different common signals are input to the second electrode and the third electrode.

2. The liquid crystal display device according to claim 1,
wherein a pulse potential is applied to one of the second electrode and the third electrode, and
a predetermined potential is applied to the other of the second electrode and the third electrode.

3. The liquid crystal display device according to claim 1,
wherein the second electrode and the third electrode are connected to a gradation reference voltage generating circuit.

4. The liquid crystal display device according to claim 1,
wherein the distance between the first electrode and the third electrode is larger than the distance between the first electrode and the second electrode.

5. The liquid crystal display device according to claim 1,
wherein the first electrode, the second electrode, and the third electrode have substantially the same width.

6. The liquid crystal display device according to claim 1,
wherein the first electrode, the second electrode, and the third electrode are comb-shaped electrodes.

7. The liquid crystal display device according to claim 1,
wherein a thickness of the liquid crystal layer in the reflective area is substantially equal to a thickness of the liquid crystal layer in the transmissive area.
